(19) United States
(12) Patent Application Publication
(10) Pub. No.: US 2026/0050826 A1
(43) Pub. Date: Feb. 19, 2026

(54) DYNAMICALLY MANAGING PROMPTS AND MODEL PARAMETERS FOR HIGH-THROUGHPUT TEXT-TO-IMAGE INFERENCE SERVING

(71) Applicant: Adobe Inc., San Jose, CA (US)

(72) Inventors: Saud lqbal, Delhi (IN); Shubham Agarwal, Durgapur (IN); Subrata Mitra, Bangalore (IN)

(21) Appl. No.: 18/808,654

(22) Filed: Aug. 19, 2024

(51) Int. Cl. G06N 20/00; G06T 11/00

(52) U.S. Cl. CPC G06N 20/00; G06T 11/00

(57) ABSTRACT

This disclosure describes one or more implementations of systems that utilizes prompt-aware, accuracy-scaling inference serving to serve prompts into generative models. For instance, the disclosed systems utilize varying approximation levels in generative models to speed up model output inferences. For example, the disclosed systems determine a set of approximation parameters for a set of generative models based on a predicted input prompt load. The disclosed systems generate an input prompt distribution mapping utilizing a historical prompt affinity mapping to the set of generative models and a prompt load distribution for the set of generative models. The disclosed systems select, for an input prompt, a generative model corresponding to a particular approximation parameter based on the input prompt distribution mapping and an approximation parameter assignment for the input prompt. The disclosed systems generate an inference output for the input prompt by utilizing the input prompt with the generative model.

### BACKGROUND

In recent years, there has been an increase in the utilization of generative models for digital content creation. For instance, individuals and businesses increasingly utilize computing devices to prompt generative models to create digital content. In many instances, existing systems enable individuals and businesses to provide requests to cause generative models to generate digital content in response to the requests. As an example, existing systems receive prompts to generate images according to a description provided by individuals and businesses and cause generative models to use the description to generate the images. In order to achieve this, many existing systems host various generative models across server systems to inference serve a large volume of prompts from individuals and businesses. Although many existing systems utilize generative models to serve content creation for input prompts from users, many of these existing systems have a number of shortcomings, particularly with regards to efficiently, flexibly, and accurately inference serving a high volume of input requests from generative models.

### SUMMARY

This disclosure describes one or more implementations of systems, non-transitory computer readable media, and computer-implemented methods that solve one or more of the following problems by intelligently managing (or distributing) input prompts to the generative models utilizing generative model approximation levels and prompt affinity-based distribution mappings to serve high-quality inference outputs while sustaining throughput under high prompt loads. For instance, the disclosed systems, to achieve high-throughput and lower latency during high input prompt loads, utilize varying approximation levels in generative models to speed up model output inferences (without model switching overhead). In addition, in some instances, the disclosed systems also utilize a prompt aware approach to achieve high quality inferencing by determining a prompt distribution mapping that indicates approximation levels to utilize for particular input prompts under specific prompt load situations. In one or more instances, the disclosed systems determine a historical prompt affinity mapping using historical prompt affinities towards approximation level variants of a generative model. Moreover, in one or more implementations, the disclosed systems utilize the historical prompt affinity mapping with a prompt load distribution to generate the prompt distribution mapping. Furthermore, in one or more implementations, the disclosed systems select a generative model variant for an incoming input prompt (to serve an inference output) by utilizing the prompt distribution mapping and an approximation parameter assigned to the input prompt (e.g., using a prompt-to-approximation level determination).

In this manner, the disclosed systems improve the efficiency and scalability of generative model inference serving while generating high quality (accurate) inference outputs (e.g., content items).

### BRIEF DESCRIPTION OF THE DRAWINGS

The detailed description is described with reference to the accompanying drawings in which:

FIG. 1 illustrates a schematic diagram of an example environment in which a prompt-aware accuracy-scaling content inference system operates in accordance with one or more implementations.

FIG. 2 illustrates a prompt-aware accuracy-scaling content inference system serving inferences via generative models for one or more input prompts in accordance with one or more implementations.

FIGS. 3A-3B illustrate an overview of a prompt-aware accuracy-scaling content inference system utilizing prompt-aware, accuracy-scaling inference serving to generate inference outputs from generative models in accordance with one or more implementations.

FIG. 4 illustrates an overview architecture of a prompt-aware accuracy-scaling content inference system in accordance with one or more implementations.

FIG. 5 illustrates a prompt-aware accuracy-scaling content inference system configuring varying approximation levels for variants of generative models in accordance with one or more implementations.

FIG. 6 illustrates a prompt-aware accuracy-scaling content inference system determining an input prompt load distribution in accordance with one or more implementations.

FIG. 7 illustrates a prompt-aware accuracy-scaling content inference system generating a historical prompt affinity mapping in accordance with one or more implementations.

FIG. 8 illustrates a prompt-aware accuracy-scaling content inference system generating a prompt distribution mapping in accordance with one or more implementations.

FIG. 9 illustrates a prompt-aware accuracy-scaling content inference system selecting a generative model for an input prompt utilizing an input prompt distribution mapping in accordance with one or more implementations.

FIG. 10 illustrates a prompt-aware accuracy-scaling content inference system utilizing load aware routing and adaptive batching in accordance with one or more implementations.

FIGS. 11-18 illustrate experimental results of an implementation of a prompt-aware accuracy-scaling content inference system in accordance with one or more implementations.

FIGS. 19A and 19B illustrate an example of a prompt-aware accuracy-scaling content inference system generating an input prompt distribution mapping in accordance with one or more implementations.

FIG. 20 illustrates a schematic diagram of a prompt-aware accuracy-scaling content inference system in accordance with one or more implementations.

FIG. 21 illustrates a flowchart of a series of acts for utilizing prompt-aware, accuracy-scaling inference serving to serve prompts into generative models in accordance with one or more implementations.

FIG. 22 illustrates a block diagram of an example computing device in accordance with one or more implementations.

### DETAILED DESCRIPTION

This disclosure describes one or more implementations of a prompt-aware accuracy-scaling content inference system that utilize prompt-aware, accuracy-scaling inference serving to serve prompts into generative models. In particular, in one or more instances, the prompt-aware accuracy-scaling content inference system utilizes varying approximation parameters across generative models at different computing clusters to control throughput speed versus accuracy of the generative models while reducing model switching overhead. Furthermore, in one or more implementations, the prompt-aware accuracy-scaling content inference system serves high quality inferences in high throughput situations by dynamically selecting prompts (e.g., prompt awareness) for the approximation level variants of the generative model.

For instance, the prompt-aware accuracy-scaling content inference system determines an input load distribution for the variants of the generative model to satisfy a threshold throughput. Furthermore, in one or more instances, the prompt-aware accuracy-scaling content inference system determines a prompt distribution mapping (e.g., a shift graph) using historical prompt affinities towards approximation level variants of a generative model and the determined input load distribution. Moreover, in one or more implementations, the prompt-aware accuracy-scaling content inference system utilizes approximation parameter assignments corresponding to input prompts with the prompt distribution mapping to redirect the input prompts to approximation level variants of the generative model to serve high quality inference outputs while satisfying a threshold throughput. Additionally, in some cases, the prompt-aware accuracy-scaling content inference system also utilizes adaptive batching.

In one or more implementations, the prompt-aware accuracy-scaling content inference system configures varying approximation levels for generative models operating in clusters of computing processing units. Indeed, in some cases, the prompt-aware accuracy-scaling content inference system utilizes multiple variants of the same generative model with configured (or modified) approximation parameters to enable varying speeds for the generative models without incurring model switching overhead (e.g., load times). In one or more implementations, the prompt-aware accuracy-scaling content inference system determines (or modifies) the approximation parameters for the generative models operating at the different clusters of computing processing units (e.g., graphical processing units (GPUs)) based on a predicted input prompt load.

In some instances, the prompt-aware accuracy-scaling content inference system configures the approximation parameters by configuring a number of skipped denoising iterations of the generative models (e.g., a text-to-image diffusion model). Indeed, in one or more implementations, the prompt-aware accuracy-scaling content inference system utilizes the approximation parameters to determine a number of denoising iterations to skip in a generative model to reuse a previously generated intermediate state (noise) from cached denoising steps of the generative model as a starting point for an input prompt. For instance, by skipping a number of denoising iterations by reusing a previously generated intermediate state (noise) from cached denoising steps of the generative model as a starting point for an input prompt, the prompt-aware accuracy-scaling content inference system reduces latency of the generative model (e.g., speeds up the generative model by changing the approximation level).

As also mentioned above, in one or more instances, the prompt-aware accuracy-scaling content inference system utilizes a prompt aware approach to achieve high quality inferencing while utilizing the varying approximation levels in generative models. In particular, in one or more implementations, the prompt-aware accuracy-scaling content inference system utilizes historical affinities between query prompts and generative model variants (operating at different approximation levels) to selectively direct (or guide) incoming prompts, via the historical affinities and a prompt load distribution, to generative model variants that utilize approximation to speed up inferences while minimizing inference quality degradation. Indeed, while speeding up inferences to meet a threshold throughput, in one or more implementations, the prompt-aware accuracy-scaling content inference system minimizes quality degradation of inferences by intelligently directing the prompts to a generative model variant operating at an approximation level using known affinities between the generative model variants and cached input prompts all while accounting for a load distribution at each of the generative model variants (e.g., using an input prompt distribution mapping).

To illustrate, in one or more implementations, the prompt-aware accuracy-scaling content inference system generates a historical prompt affinity mapping. To generate the historical prompt affinity mapping, in one or more cases, the prompt-aware accuracy-scaling content inference system determines affinities between historical input prompts and particular approximation level variants of a generative model. For instance, the prompt-aware accuracy-scaling content inference system determines, for a historical input prompt, which generative model variant (e.g., which approximation level variant) generates an inference output that satisfies an inference output quality threshold (e.g., an image quality threshold) as an affinity between the historical input prompt and the generative model variant (e.g., using a prompt-to-approximation level determination) for the historical prompt affinity mapping.

Furthermore, in one or more instances, the prompt-aware accuracy-scaling content inference system determines, to achieve a threshold throughput, a load distribution of prompts for generative models operating with different approximation parameters. Indeed, in some cases, the load distribution of prompts differs from the allocation mapping between input prompts and approximation values. To achieve the threshold throughput, in one or more implementations, the prompt-aware accuracy-scaling content inference system utilizes the historical prompt affinity mapping and the distribution load to generate a prompt distribution mapping (that includes a prompt shift probability that indicates a redirection probability for an input prompt in response to a selected approximation level for the input prompt). Indeed, in one or more instances, the prompt-aware accuracy-scaling content inference system utilizes the prompt distribution mapping to identify, for an input prompt, an available generative model variant (based on the distribution load) with an approximation level that is the best available match to an optimal approximation level assigned to the particular input prompt (e.g., to minimize quality degradation).

Additionally, in one or more instances, the prompt-aware accuracy-scaling content inference system selects a generative model variant for an incoming input prompt (to serve an inference output) by utilizing the prompt distribution mapping and an approximation parameter assigned to the input prompt. For example, upon receiving an input prompt, the prompt-aware accuracy-scaling content inference system determines an approximation parameter assignment for the input prompt (e.g., using a prompt-to-approximation level determination). Additionally, in one or more implementations, the prompt-aware accuracy-scaling content inference system determines affinities between the input prompt and a historical prompt associated with a target approximation value (e.g., approximation levels utilized for the historical prompt to achieve a threshold quality inference from a generative model). Moreover, in one or more implementations, the prompt-aware accuracy-scaling content inference system utilizes the prompt distribution mapping to select an available generative model variant (based on the distribution load) with an approximation level that is the best available match to the target approximation level assigned to the particular input prompt.

Furthermore, in one or more embodiments, the prompt-aware accuracy-scaling content inference system utilizes the selected generative model variant to generate an inference output for the input prompt. For instance, the prompt-aware accuracy-scaling content inference system identifies, as the target approximation value, a number of denoising iterations to skip for a generative model (e.g., a text-to-image diffusion model) to generate an inference (e.g., an image or other content item) for the input prompt. In some cases, the prompt-aware accuracy-scaling content inference system retrieves a previously generated intermediate state (noise) from cached denoising steps of the generative model corresponding to the historical prompt that matched with the input prompt to generate an inference output for the input prompt.

Additionally, in one or more implementations, the prompt-aware accuracy-scaling content inference system also utilizes adaptive batching to sustain throughput while inference serving a high load of input prompts. For instance, the prompt-aware accuracy-scaling content inference system utilizes uniform routing of input prompts to generative models (based on approximation level assignments as described above) when an input prompt load is below a threshold load. Moreover, in one or more implementations, the prompt-aware accuracy-scaling content inference system utilizes batching to route multiple input prompts into particular generative models when an input prompt load meets (or satisfies) a threshold load.

As mentioned above, many conventional systems suffer from a number of technical deficiencies. For instance, many conventional systems inefficiently utilize generative models to serve inferences in response to prompts. To illustrate, conventional systems oftentimes are unable to efficiently handle a high number of requests for inference serving via generative models. Indeed, in many cases, the conventional systems require a substantial amount of time per inference output (e.g., seconds, minutes). As an input load increases (e.g., thousands, millions of input prompt requests per day), such conventional systems utilize a substantial number of computational resources and time. Indeed, due to the high volume of requests and the time per request, many conventional systems experience latency issues and bottlenecks. In some cases, load times sometimes prevent conventional systems from successfully serving a received request load.

Furthermore, many conventional systems that attempt to resolve the inefficiencies of serving a high throughput of requests result in inaccurate inferences. For example, in some cases, conventional systems reduce latency by using approximate caching to selectively skip certain iterative denoising processes and reuse previously generated intermediate noise in generative models. However, oftentimes, such approximate caching approaches lead to a substantial degradation of quality in the output inference images. Indeed, in most cases, the improved latency results in unusable, low quality output images.

Some conventional systems change model sizes or model types to handle higher request loads. However, such conventional systems also often result in a substantial degradation of output quality. In particular, in many cases, conventional systems utilize smaller generative models or less-optimal model types to speed up inference serving at the cost of quality degradation in the resulting output images. In addition, conventional systems that change model sizes or model types often also result in inefficiencies because of load times caused by switching between models. Indeed, in some cases, conventional systems take minutes to load models and, accordingly, incur substantial model switching overhead while inference serving.

Moreover, in some cases, conventional systems distribute prompts to faster (less accurate) models to sustain throughput under a high load of input prompt requests. Oftentimes, such an approach improves throughput (or latency) at the cost of output image quality. In particular, in such conventional systems, input prompts that are distributed (e.g., randomly) to smaller (or faster) generative models often result in low quality output images. As a result, oftentimes, such conventional systems sustain throughput while having a substantial portion of the served inferences being inaccurate or low in quality.

Due to the above mentioned inefficiencies and inaccuracies, conventional systems are often inflexible. For instance, many conventional systems are slow and computationally expensive such that they are unable to scale to larger networks that serve a high number of inferences (e.g., due to increases in load time and computational resource limits). Furthermore, in some cases, conventional systems that selectively utilize faster generative models for high throughput result in substantial quality degradation. Such conventional systems are also inflexible as the quality degradation results in unusable inference outputs when scaled to larger networks (or during high throughput times).

The prompt-aware accuracy-scaling content inference system provides a number of advantages relative to these conventional systems. For example, the prompt-aware accuracy-scaling content inference system improves the efficiency of inference serving from generative models while sustaining output quality (or accuracy). To illustrate, unlike many conventional systems, the prompt-aware accuracy-scaling content inference system improves computational efficiency and load times in large-scale deployments of generative models for image (or other content) generation. Indeed, by utilizing varying approximation parameters across generative models at different computing clusters, the prompt-aware accuracy-scaling content inference system improves latency speed of serving inferences for input prompts to sustain a throughput for a high input prompt load. In addition, by utilizing modified approximation parameters across a singular version of a generative model, the prompt-aware accuracy-scaling content inference system also reduces (or eliminates) timing inefficiencies caused by generative model switching overhead. Accordingly, in one or more implementations, the prompt-aware accuracy-scaling content inference system serves inferences for a substantial (or large scale) of input prompt requests with improved latency.

In addition to improving speed, unlike many conventional systems (as described above), the prompt-aware accuracy-scaling content inference system also maintains inference output quality across the generative models while efficiently handling a substantial input prompt load. For instance, as mentioned above, the prompt-aware accuracy-scaling content inference system utilizes a prompt aware approach to achieve high quality inferencing while utilizing the varying approximation levels in generative models. Unlike many conventional systems that result in quality degradation when distributing input prompts to faster generative models, the prompt-aware accuracy-scaling content inference system selectively utilizes input prompts (e.g., using the prompt distribution mapping) at particular approximation levels of the generative models to maintain (or minimize) a quality of the inference outputs while improving the speed of generating the inference outputs from the generative models.

In addition, the prompt-aware accuracy-scaling content inference system also utilizes an adaptive batching approach to improve throughput of generative model inferencing systems. For instance, unlike conventional systems that suffer from increased latency when batching, the prompt-aware accuracy-scaling content inference system, in some cases, utilizes an adaptive batching approach that optimizes for high-throughput. For example, the prompt-aware accuracy-scaling content inference system utilizes batching during high loads to enable queries to run quicker and enabling a higher throughput while reducing latency. Moreover, under a low input prompt load, the prompt-aware accuracy-scaling content inference system utilizes uniform routing to avoid lower latency speeds associated with batching when sustaining throughput is possible via uniform routing.

Indeed, due to the improvement in speed and output quality maintenance achieved by the prompt-aware accuracy-scaling content inference system, the prompt-aware accuracy-scaling content inference system improves the flexibility of inference serving through generative models. In particular, in one or more implementations, the prompt-aware accuracy-scaling content inference system enables the ease of scaling inference serving via generative models to a significant number of input requests (e.g., during a high load) without degradation in output quality. Accordingly, in one or more implementations, the prompt-aware accuracy-scaling content inference system easily scales to large network sizes while outputting useable inference outputs for input requests. In addition, unlike many conventional systems that require new model variant generation when a base model is updated, the prompt-aware accuracy-scaling content inference system, when the base generative model is updated, loads the updated base generative model to utilize the various approximation level configurations without having to update new model variants.

In one or more instances, implementations of the prompt-aware accuracy-scaling content inference system resulted in a reduction of latency service level objective (SLO) violations, higher average inference output quality, and higher throughput in comparison to many conventional approaches (e.g., as illustrated in the experiment results below).

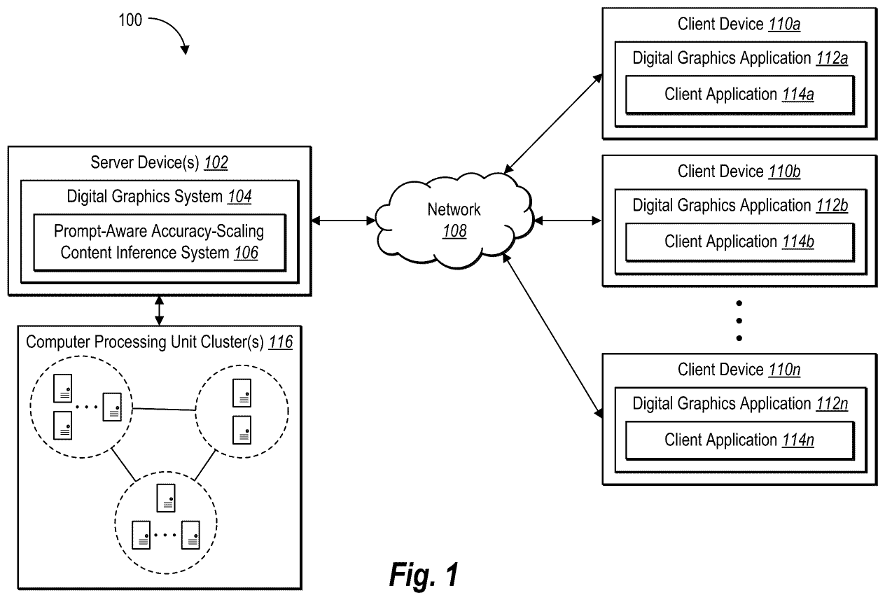

Turning now to the figures, FIG. 1 illustrates a schematic diagram of one or more implementations of a system 100 (or environment) in which a prompt-aware accuracy-scaling content inference system operates in accordance with one or more implementations. As illustrated in FIG. 1, the system 100 includes a server device(s) 102, a network 108, client devices 110a-110n, and processing unit cluster(s) 116. As further illustrated in FIG. 1, the server device(s) 102 and the client devices 110a-110n communicate via the network 108.

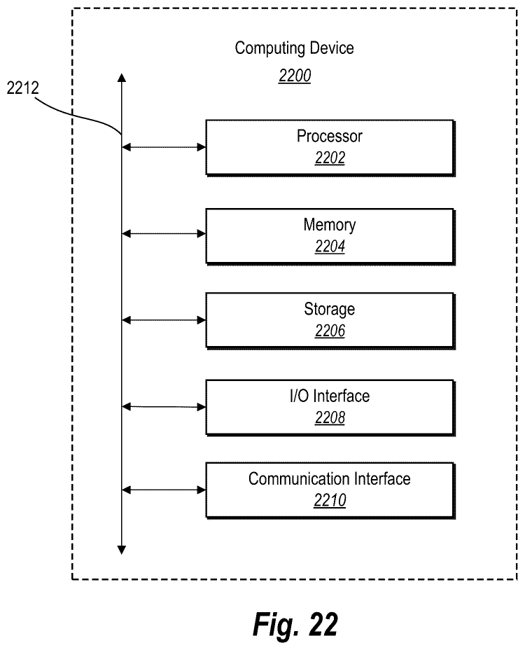

In one or more implementations, the server device(s) 102 includes, but is not limited to, a computing (or computer) device (as explained below with reference to FIG. 22. As shown in FIG. 1, the server device(s) 102 include a digital graphics system 104 which further includes the prompt-aware accuracy-scaling content inference system 106. The digital graphics system 104 is able to generate, train, store, deploy, and/or utilize various machine learning models for various machine learning applications, such as, but not limited to, image tasks, video tasks, text tasks, classification tasks, text recognition tasks, voice recognition tasks, artificial intelligence tasks, and/or digital analytics tasks. As an example, the digital graphics system 104 generates digital images utilizing text-to-image diffusion models with text input prompts received from client devices 110a-110n.

Moreover, as explained below, the prompt-aware accuracy-scaling content inference system 106, in one or more embodiments, utilizes prompt-aware, accuracy-scaling inference serving to serve prompts into generative models (in accordance with one or more implementations herein). In some implementations, the prompt-aware accuracy-scaling content inference system 106 system configures varying approximation levels for generative models operating in clusters of computing processing units. Moreover, the prompt-aware accuracy-scaling content inference system 106, in one or more implementations, utilizes a prompt aware approach to achieve high quality inferencing while utilizing the varying approximation levels in generative models. For example, the prompt-aware accuracy-scaling content inference system 106 dynamically manages approximation parameter configurations for generative models to selectively schedule (or distribute) input prompts at the generative models to serve high-quality inference outputs while sustaining throughput under high input prompt loads (in accordance with one or more implementations herein).

As further shown in FIG. 1, the system 100 includes the computer processing unit cluster(s) 116. In some instances, the computer processing unit cluster(s) 116 includes, but is not limited to, a computing (or computer) device (as explained below with reference to FIG. 22). Indeed, in one or more cases, the computer processing unit of the processing unit cluster(s) 116 are configured to implement one or more generative models. For instance, a cluster of computing processing units from the computing processing unit cluster(s) 116 implements a version of a generative model (e.g., at a particular approximation level as described herein). Indeed, in one or more cases, the computing processing unit cluster(s) 116 each operate a version of a generative model using varying approximation levels as configured by the prompt-aware accuracy-scaling content inference system 106 (in accordance with one or more implementations herein). In one or more instances, the computer processing unit cluster(s) 116 include one or more clusters of graphics processing units (GPUs).

Furthermore, as shown in FIG. 1, the system 100 includes the client devices 110a-110n. In one or more implementations, the client devices 110a-110n includes, but are not limited to, a mobile device (e.g., smartphone, tablet), a laptop, a desktop, or any other type of computing device, including those explained below with reference to FIG. 22. In certain implementations, although not shown in FIG. 1, the client devices 110a-110n are operated by a user to perform a variety of functions (e.g., via the digital graphics applications 112a-112n). For example, the client devices 110a-110n perform functions such as, but not limited to, capturing and/or editing of digital images and/or videos, playing digital images and/or videos, requesting digital content creations via generative models (e.g., using voice prompts, using text prompts, using user interface selections), and/or utilize various machine learning models for various machine learning applications, such as, but not limited to, image tasks, video tasks, text tasks, classification tasks, text recognition tasks, voice recognition tasks, artificial intelligence tasks, and/or digital analytics tasks.

To access the functionalities of the prompt-aware accuracy-scaling content inference system 106 (as described above), in one or more implementations, a user interacts with the digital graphics applications 112a-112n on the client devices 110a-110n. For example, the digital graphics applications 112a-112n include one or more software applications installed on the client devices 110a-110n (e.g., to utilize machine learning or generative models in accordance with one or more implementations herein). In some cases, the digital graphics applications 112a-112n are hosted on the server device(s) 102. In addition, when hosted on the server device(s) 102, the digital graphics applications 112a-112n are accessed by the client devices 110a-110n through a web browser and/or another online interfacing platform and/or tool.

Although FIG. 1 illustrates the prompt-aware accuracy-scaling content inference system 106 being implemented by a particular component and/or device within the system 100 (e.g., the server device(s) 102), in some implementations, the prompt-aware accuracy-scaling content inference system 106 is implemented, in whole or in part, by other computing devices and/or components in the system 100. For example, in some implementations, the prompt-aware accuracy-scaling content inference system 106 is implemented on the client devices 110a-110n within the digital graphics applications 112a-112n (e.g., via a client application 114a-114n). Indeed, in one or more implementations, the description of (and acts performed by) the prompt-aware accuracy-scaling content inference system 106 are implemented (or performed by) the client applications 114a-114n when the client devices 110a-110n implement the prompt-aware accuracy-scaling content inference system 106. More specifically, in some instances, the client devices 110a-110n (via an implementation of the prompt-aware accuracy-scaling content inference system 106 on the client application 114a-114n) utilize prompt-aware, accuracy-scaling inference serving to serve prompts into generative models (in accordance with one or more implementations herein). In some cases, the prompt-aware accuracy-scaling content inference system 106 is implemented on the computer processing unit cluster(s) 116.

Additionally, as shown in FIG. 1, the system 100 includes the network 108. As mentioned above, in some instances, the network 108 enables communication between components of the system 100. In certain implementations, the network 108 includes a suitable network and may communicate using any communication platforms and technologies suitable for transporting data and/or communication signals, examples of which are described with reference to FIG. 22. Furthermore, although FIG. 1 illustrates the server device(s) 102 and the client devices 110a-110n communicating via the network 108, in certain implementations, the various components of the system 100 communicate and/or interact via other methods (e.g., the server device(s) 102 and the client devices 110a-110n communicating directly, the computer processing unit cluster(s) 116 and the client devices 110a-110n communicating directly).

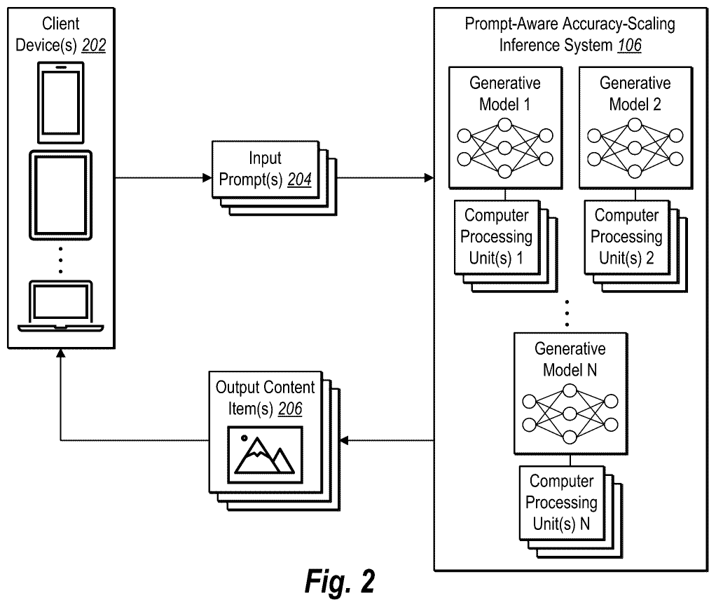

As mentioned above, the prompt-aware accuracy-scaling content inference system 106 utilizes generative models to serve inference content outputs in response to input prompts from one or more client devices. For instance, FIG. 2 illustrates the prompt-aware accuracy-scaling content inference system 106 serving inferences via generative models for one or more input prompts. Indeed, as shown in FIG. 2, the prompt-aware accuracy-scaling content inference system 106 receives input prompt(s) 204 from client device(s) 202. In one or more instances, the input prompt(s) 204 includes various amounts (or load sizes) of input prompt(s) 204 (e.g., hundreds, thousands, millions).

In addition, as shown in FIG. 2, the prompt-aware accuracy-scaling content inference system 106 utilizes the input prompt(s) 204 with generative models(s) 1-N operating on computer processing unit(s) 1-N to serve inferences (e.g., output content item(s) 206) to the client device(s) 202. For instance, the prompt-aware accuracy-scaling content inference system 106 utilizes prompt-aware, accuracy-scaling inference serving (in accordance with one or more implementations herein) to dynamically utilize prompts (e.g., the input prompt(s) 204) with particular generative models (e.g., the generative model(s) 1-N). Indeed, as shown in FIG. 2, upon selecting (or assigning) input prompts to particular generative models, the prompt-aware accuracy-scaling content inference system 106 generates, utilizing the generative model(s) 1-N, output content item(s) 206 (in response to the input prompt(s) 204). In one or more instances, the output content item(s) 206 include images generated using a text-to-image diffusion model that generates images depicting a descriptor described in an input text prompt.

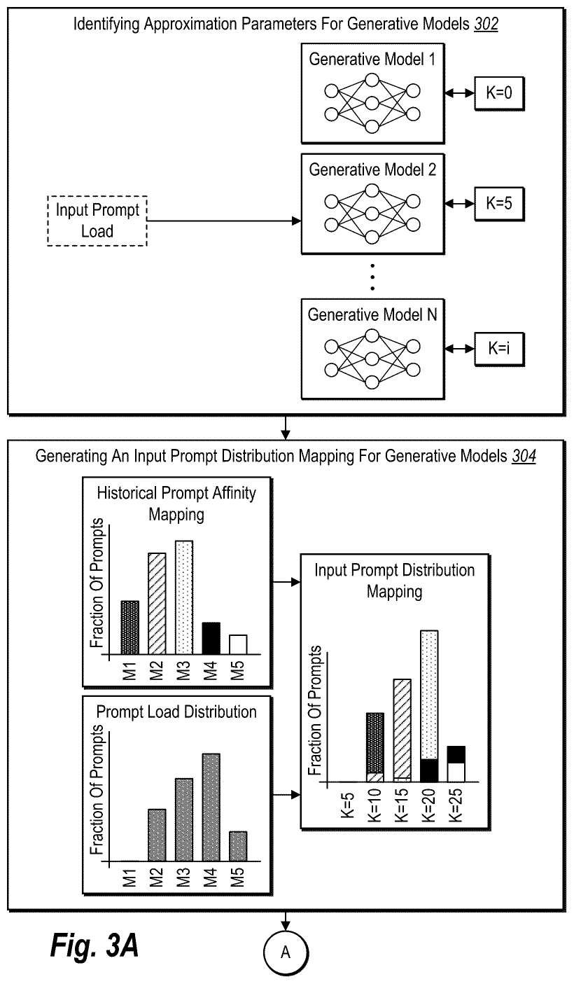

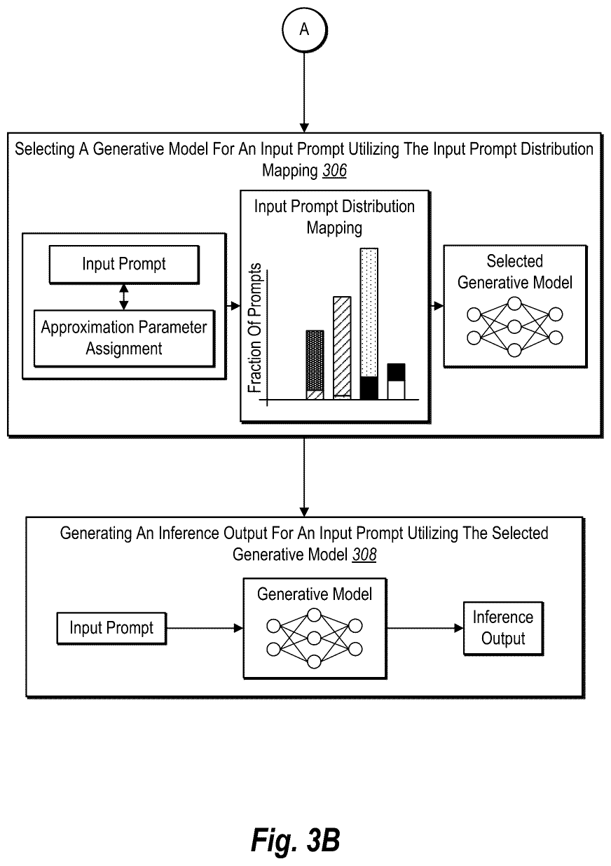

As mentioned above, in one or more implementations, the prompt-aware accuracy-scaling content inference system 106 dynamically manages (or selectively schedules) input prompts at the generative models having varying approximation parameter configurations to serve high-quality inference outputs while sustaining throughput under high input prompt loads. For instance, FIGS. 3A and 3B illustrate an overview of the prompt-aware accuracy-scaling content inference system 106 utilizing prompt-aware, accuracy-scaling inference serving to generate inference outputs from generative models (using input prompts). In particular, FIGS. 3A and 3B illustrate the prompt-aware accuracy-scaling content inference system 106 identifying approximation parameters for generative models, generating an input prompt distribution mapping for generative models, selecting a generative model for an input prompt utilizing the input prompt distribution mapping, and generating an inference output for an input prompt utilizing the selected generative model.

For instance, as shown in an act 302 of FIG. 3A, the prompt-aware accuracy-scaling content inference system 106 identifies approximation parameters for generative models. In particular, as shown in FIG. 3A, the prompt-aware accuracy-scaling content inference system 106 configures varying approximation levels for generative models operating in clusters of computing processing units (e.g., based on a predicted input prompt load). For instance, the prompt-aware accuracy-scaling content inference system 106 configures a number of skipped denoising iterations (e.g., K) of the generative models (e.g., a text-to-image diffusion model).

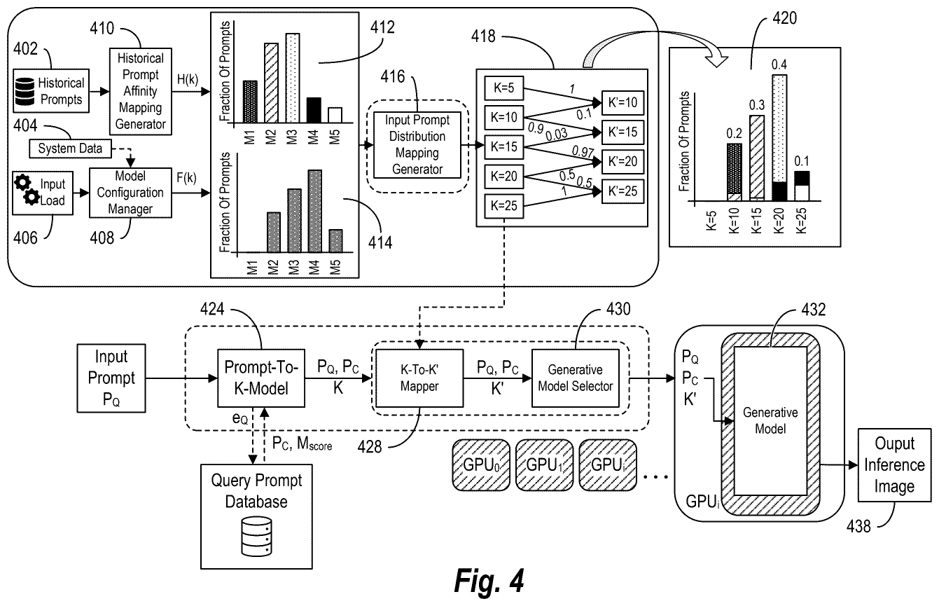

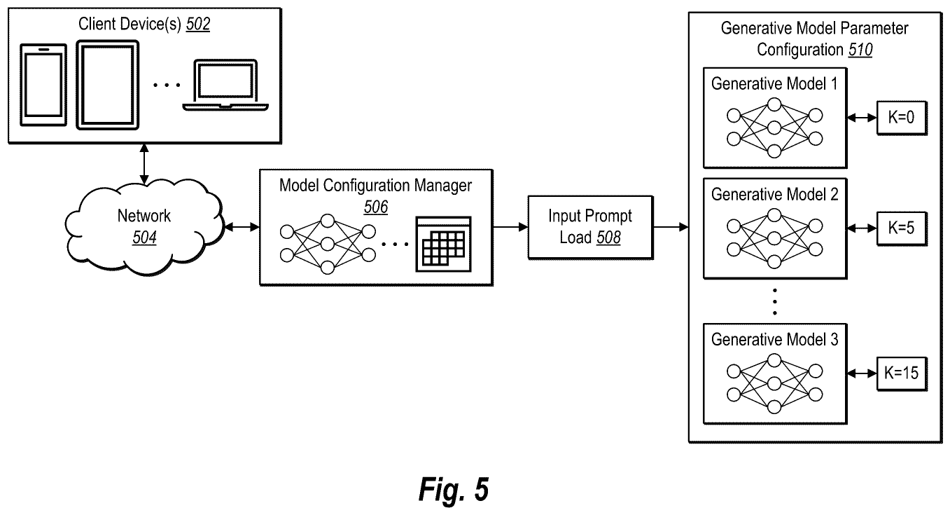

For instance, as shown in FIG. 3A, the prompt-aware accuracy-scaling content inference system 106 modifies (or configures) an approximation parameter to forego skipping iterations (e.g., K=0) for a generative model 1. In addition, as shown in FIG. 3A, the prompt-aware accuracy-scaling content inference system 106 modifies (or sets) an approximation parameter to skip various numbers of iterations (e.g., K=5, K=i) for one or more other generative models (e.g., generative model 2, generative model N). Indeed, the prompt-aware accuracy-scaling content inference system 106 configures (or identifies) approximation parameters for generative models as described below (e.g., in relation to FIGS. 4 and 5).

In one or more instances, an approximation parameter includes a setting (or indicator) that signals an approximation level or generative model variant (at an approximation level). For instance, an approximation parameter includes a value that indicates an approximation level to utilize for a generative model. In some cases, an approximation parameter includes a value that indicates a number of denoising iterations to skip for a diffusion model (as the generative model). In one or more instances, an approximation parameter includes a variety of generative model parameters, such as, but not limited to, an approximation level, a number of skipped iterations, a number of model layers, and/or model size.

In addition, in one or more implementations, a generative model includes a machine learning model that generates digital content conditioned on an input prompt. In particular, a generative model receives an input prompt having a description and the generative model (via deep learning) generates digital content depicting the description of the input prompt. In some instances, a generative model includes a diffusion model (e.g., a text-to-image diffusion model).

In some cases, a generative model (e.g., a machine learning model) iteratively denoises a noise representation (e.g., Gaussian noise, random noise) to generate a digital image. In some instances, a generative model includes a deep generative model that (in training) adds noise to training data and reverses the noise (e.g., denoising) to recover the training data (to learn to remove noise to generate a representation of the training data). Indeed, in one or more embodiments, a generative model denoises random noise representations to generate images. For instance, the prompt-aware accuracy-scaling content inference system 106 utilizes, as a generative model, a text-to-image diffusion model as described in US Patent Application Publication No. 2024/0135514A1, entitled, Modifying Digital Images Via Multi-Layered Scene Completion Facilitated by Artificial Intelligence, which is incorporated herein by reference in its entirety.

Although one or more embodiments describe utilizing the prompt-aware accuracy-scaling content inference system 106 with a text-to-image diffusion model, the prompt-aware accuracy-scaling content inference system 106, in one or more implementations, utilizes the prompt-aware accuracy scaling approach (in accordance with one or more implementations herein) on a variety of generative models (e.g., text-to-video models) and/or other machine learning models.

Furthermore, in one or more cases, a machine learning model includes a computer algorithm (or set of algorithms) trained and/or tuned based on inputs to determine inferences or approximate unknown functions. In some cases, a machine learning model refers to an algorithm (or set of algorithms) that implements deep learning techniques to model data, predict data, and/or generate inferences. For example, machine learning model includes, but is not limited to, a neural network (e.g., a convolutional neural network (CNN), a recurrent neural network (RNN)), attention transformers, and/or regression models, and/or clustering models.

Additionally, in one or more cases, an input prompt includes a query representing a request to generate a particular content item. For example, an input prompt includes a text, voice, or selection query that indicates a request to generate a particular content item and a descriptor for the content item request. In one or more implementations, the input prompt includes a text query, a voice command, or a user selection of one or more descriptors to build a request to generate a content item. Indeed, in one or more cases, an input prompt is utilized with a generative model to cause the generative model to generate a content item (e.g., an image, video, writing) that is conditioned on the input prompt such that the content item is reflective of the description or request within the input prompt.

As further shown in an act 304 of FIG. 3A, the prompt-aware accuracy-scaling content inference system 106 generates an input prompt distribution mapping for generative models. In particular, in one or more instances, the prompt-aware accuracy-scaling content inference system 106 generates an input prompt distribution mapping that indicates a redirection probability for an input prompt in response to a selected approximation level for the input prompt. For instance, as shown in the act 304, the prompt-aware accuracy-scaling content inference system 106 generates a historical prompt affinity mapping using affinities between historical input prompts and particular approximation level variants of a generative model. In addition, as shown in the act 304, the prompt-aware accuracy-scaling content inference system 106 determines, to achieve a threshold throughput, a load distribution of prompts for generative models operating with different approximation parameters. Moreover, as shown in the act 304, the prompt-aware accuracy-scaling content inference system 106 utilizes the historical prompt affinity mapping and the distribution load to generate a prompt distribution mapping. Indeed, the prompt-aware accuracy-scaling content inference system 106 generates a prompt distribution mapping as described below (e.g., in relation to FIGS. 4 and 6-8).

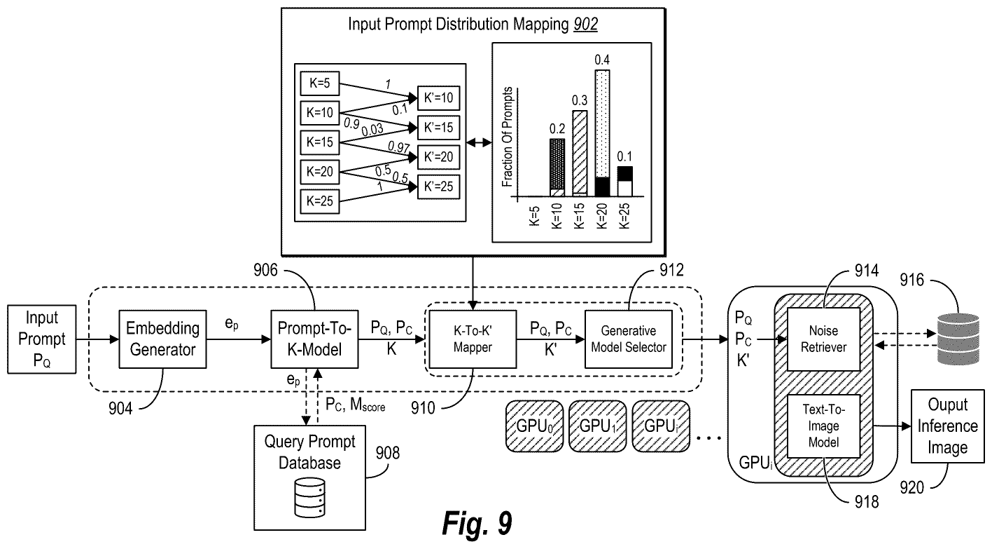

In addition, as shown in an act 306 of FIG. 3B, the prompt-aware accuracy-scaling content inference system 106 selects a generative model for an input prompt utilizing the input prompt distribution mapping. For instance, as shown in the act 306 of FIG. 3B, the prompt-aware accuracy-scaling content inference system 106 determines an approximation parameter assignment for the input prompt (e.g., using a prompt-to-approximation level determination). Moreover, as shown in the act 306, the prompt-aware accuracy-scaling content inference system 106 utilizes the prompt distribution mapping to select an available generative model variant (based on the distribution load) with an approximation level that is the best available match to the target approximation level assigned to the particular input prompt. Indeed, the prompt-aware accuracy-scaling content inference system 106 selects a generative model for an input prompt as described below (e.g., in relation to FIGS. 4 and 9).

In one or more instances, a historical prompt affinity mapping includes a mapping between historical prompts (e.g., cached prompts) and generative model variants. For example, the historical prompt affinity mapping utilizes affinities between cached prompts and generative models with approximation levels that result in a threshold inference quality for the cached prompt. In some cases, the historical prompt affinity mapping includes a histogram that creates relationships between one or more historical prompts and particular approximation levels of a generative model.

In addition, in one or more cases, a prompt load distribution includes a representation that indicates a fraction of prompts to process at various approximation levels of a generative model to achieve a threshold (or target) throughput. For instance, a prompt load distribution indicates a percentage of prompts to process at one or more variants of a generative model (operating at different latency speeds due to different approximation levels) to meet or satisfy a target throughput. In some cases, a prompt load distribution is represented as a histogram of a fraction of prompts to process at different approximation level variants of a generative model.

Moreover, in one or more embodiments, an input prompt distribution mapping includes a data representation that uses a historical prompt affinity mapping and a prompt load distribution to determine a redirection strategy for one or more incoming prompts to meet or satisfy a target throughput while minimizing inference output quality degradation. In particular, in one or more cases, an input prompt distribution mapping includes one or more redirection probabilities to shift input prompts from assigned approximation levels to a redirected approximation level to fit the prompt load distribution. In some cases, the input prompt distribution mapping includes a shift graph generated from the historical prompt affinity mapping and the prompt load distribution.

Furthermore, as shown in act 308 of FIG. 3B, the prompt-aware accuracy-scaling content inference system 106 generates an inference output for an input prompt utilizing the selected generative model. For instance, upon selecting a generative model (with a particular approximation level) for the input prompt, the prompt-aware accuracy-scaling content inference system 106 utilizes the input prompt with the generative model, at the determined approximation level, to generate an inference output. In some cases, the prompt-aware accuracy-scaling content inference system 106 utilizes the input prompt (e.g., a text prompt) with a text-to-image diffusion model to identify affinities between the input prompt and a historical prompt associated with a target approximation value (e.g., approximation levels utilized for the historical (cached) prompt to achieve a threshold quality inference from a generative model). Moreover, the prompt-aware accuracy-scaling content inference system 106, utilizes the input text prompt with noise (of the identified historical prompt) starting at a denoising iteration corresponding to the approximation level of the generative model to generate an image (as the inference output) for the input text prompt. Indeed, the prompt-aware accuracy-scaling content inference system 106 generating an inference output for an input prompt utilizing a selected generative model is described in greater detail below (e.g., in relation to FIGS. 4 and 9).

In one or more instances, an inference output includes a content item generated by a generative model condition on an input prompt. For instance, an inference output includes digital content items, such as, but not limited to, digital images, digital videos, electronic documents, and/or text responses. For instance, an image (sometimes referred to as a digital image) includes a digital symbol, picture, icon, and/or other visual illustration depicting one or more subjects. For instance, an image includes a digital file having a visual illustration and/or depiction of a subject (e.g., human, place, or thing). Indeed, in some implementations, an image includes, but is not limited to, a digital file with the following extensions: JPEG, TIFF, BMP, PNG, RAW, or PDF. In some instances, an image includes a frame from a digital video file having an extension such as, but not limited to the following extensions: MP4, MOV, WMV, or AVI.

Additionally, FIG. 4 illustrates an overview architecture of the prompt-aware accuracy-scaling content inference system 106 (in accordance with one or more implementations herein). For instance, FIG. 4 illustrates the prompt-aware accuracy-scaling content inference system 106 managing (or distributing) input prompts to the generative models utilizing generative model approximation levels and prompt affinity-based distribution mappings to serve high-quality inference outputs while sustaining throughput under high prompt loads. In particular, FIG. 4 illustrates the prompt-aware accuracy-scaling content inference system 106 dynamically selecting input prompts for generative models configured at varying approximation levels to serve inference outputs for the prompts (using an input prompt distribution mapping in accordance with one or more implementations herein).

As shown in FIG. 4, the prompt-aware accuracy-scaling content inference system 106 utilizes a prompt allocation solver to generate an input prompt distribution mapping 418 to selectively schedule prompts to generative models. In addition, as shown in FIG. 4, the prompt-aware accuracy-scaling content inference system 106 utilizes the input prompt distribution mapping 418 to selectively schedule an input prompt P_{Q} to generative model. Indeed, as shown in FIG. 4, the prompt-aware accuracy-scaling content inference system 106 selects a generative model for the input prompt P_{Q} to generate an output inference image 438 for the input prompt P_{Q}.

For example, as shown in FIG. 4, the prompt-aware accuracy-scaling content inference system 106 determines a prompt load distribution 414. In particular, as shown in FIG. 4, the prompt-aware accuracy-scaling content inference system 106 utilizes input load data 406 (and system data 404) with a model configuration manager 408 to determine a prompt load distribution 414. In some cases, the prompt-aware accuracy-scaling content inference system 106 determines the prompt load distribution 414 utilizing a predicted input load based on the input load data 406 and/or the system data 404. In some cases, system data 404 includes, but is not limited to, configured latency thresholds, throughput targets, resource allocation settings, and/or computer processing unit cluster settings.

Furthermore, in one or more instances, the prompt-aware accuracy-scaling content inference system 106, via the model configuration manager 408, also utilizes the input load data 406 (and system data 404) to determine approximation parameter configurations for the generative models. For instance, the prompt-aware accuracy-scaling content inference system 106 utilizes the model configuration manager 408 with the input load data 406 and the system data 404 to determine a number of variants of a generative model to utilize and an approximation level for the variants of the generative model. Indeed, in one or more instances, the prompt-aware accuracy-scaling content inference system 106 determines the prompt load distribution 414 by determining the fraction of an input load to serve at each of the variants of the generative model to meet a throughput target.

Additionally, as shown in FIG. 4, the prompt-aware accuracy-scaling content inference system 106 generates a historical prompt affinity mapping 412. For instance, as shown in FIG. 4, the prompt-aware accuracy-scaling content inference system 106 utilizes historical prompts 402, via a historical prompt affinity mapping generator 410, to generate the historical prompt affinity mapping 412. In particular, as shown in FIG. 4, the prompt-aware accuracy-scaling content inference system 106 generates the historical prompt affinity mapping 412 as a prompt-to-generative model approximation level affinity histogram to represent affinities (e.g., based on inference output quality) between historical prompts (e.g., fractions of prompts) to variants of a generative model operating at different approximation levels (e.g., “M1,” “M2,” “M3,” “M4,” “M5”).

As further shown in FIG. 4, the prompt-aware accuracy-scaling content inference system 106 generates an input prompt distribution mapping 418. For instance, as shown in FIG. 4, the prompt-aware accuracy-scaling content inference system 106 utilizes the prompt load distribution 414 and the historical prompt affinity mapping 412 to generate the input prompt distribution mapping 418 (via the input prompt distribution mapping generator 416). For example, the prompt-aware accuracy-scaling content inference system 106 generates the input prompt distribution mapping 418 to represent a redirection probability captured as a shift graph for the historical prompt affinity mapping 412 to fit (or account for) the prompt load distribution 414. Indeed, in some instances (as shown in FIG. 4), the prompt-aware accuracy-scaling content inference system 106 utilizes a histogram 420 to represent the input prompt distribution mapping 418.

Additionally, as shown in FIG. 4, the prompt-aware accuracy-scaling content inference system 106 utilizes input prompt scheduler (e.g., during runtime) to select a generative model for an input prompt to serve an output inference (in accordance with one or more implementations herein). For instance, as shown in FIG. 4, the prompt-aware accuracy-scaling content inference system 106 receives the input prompt P_{Q} and identifies a cached prompt P_{C} that matches the input prompt P_{Q} (via a prompt-to-K-model 424). Then, as shown in FIG. 4, the prompt-aware accuracy-scaling content inference system 106 assigns an approximation parameter K to the input prompt P_{Q} from the cached prompt P_{C}. Furthermore, as shown in FIG. 4, the prompt-aware accuracy-scaling content inference system 106 utilizes a k-to-k′ mapper 428 with the input prompt distribution mapping 418 to determine a redirected approximation parameter K′. Furthermore, as shown in FIG. 4, the prompt-aware accuracy-scaling content inference system 106 utilizes the redirected approximation parameter K′ to select a generative model 432 (from the GPU₀ to GPUᵢ) via the generative model selector 430. Moreover, as shown in FIG. 4, the prompt-aware accuracy-scaling content inference system 106 utilizes the selected generative model 432 at a particular approximation level with the input prompt P_{Q} (based on the cached prompt P_{C} and the redirected approximation parameter K′) to generate an output inference image 438 for the input prompt P_{Q}.

In some cases, the prompt-aware accuracy-scaling content inference system 106 utilizes the architecture illustrated in FIG. 4 as an asynchronous process. For instance, the prompt-aware accuracy-scaling content inference system 106 utilizes the prompt allocation solver to generate input prompt distribution mappings to continuously (e.g., in real time, in near real time, or in a scheduled frequency, such as, every 30 minutes, every day, every 10 minutes) generate updated input prompt distribution mappings to handle varying input prompt loads predicted (or identified) at varying times. In addition, as a separate process, the prompt-aware accuracy-scaling content inference system 106 receives input prompts and schedules input prompts to an appropriate generative model variant operating at a particular approximation level while checking (or accounting for) an updated input prompt distribution mapping that reflects the most current (or up-to-date) input load situations.

Although one or more embodiments describes generating an input prompt distribution mapping and selecting generative models for an input prompt asynchronously, the prompt-aware accuracy-scaling content inference system 106, in one or more implementations, synchronously generates an input prompt distribution mapping to select a generative model for an input prompt.

As mentioned above, in one or more implementations, the prompt-aware accuracy-scaling content inference system 106 configures varying approximation levels for variants of generative models operating in clusters of computing processing units. For example, FIG. 5 illustrates the prompt-aware accuracy-scaling content inference system 106 configuring varying approximation levels for variants of generative models. For instance, as shown in FIG. 5, the prompt-aware accuracy-scaling content inference system 106 utilizes a model configuration manager 506 to determine, from existing activity from client device(s) 502 over a network 504, a predicted input prompt load 508. Indeed, in some cases, the predicted input prompt load 508 includes a number of expected input prompt queries for a generative model. Furthermore, as shown in FIG. 5, the prompt-aware accuracy-scaling content inference system 106 utilizes the predicted input prompt load 508 to determine a generative model parameter configuration 510. As shown in FIG. 5, the prompt-aware accuracy-scaling content inference system 106 determines varying approximation parameters K for variants of a generative model (e.g., individual variants illustrated as generative model 1, generative model 2, generative model 3).

In some cases, the prompt-aware accuracy-scaling content inference system 106 determines a predicted input prompt load 508 based on historical user activity data. For instance, the prompt-aware accuracy-scaling content inference system 106 determines historical input prompt loads for various time periods and utilizes the historical input prompt loads to predict (or determine) an input prompt load for a future time period. In some instances, the prompt-aware accuracy-scaling content inference system 106 utilizes a number of active client devices operating interacting with a graphical user interface (or front end platform) of the generative models (e.g., via digital graphics system 104 and/or the digital graphics applications 112a-112n) to determine a predicted input prompt load. For instance, the prompt-aware accuracy-scaling content inference system 106 utilizes the historical and/or present activity data with a predictive model to determine a predicted input prompt load. In some cases, the prompt-aware accuracy-scaling content inference system 106 generates a predicted input prompt load utilizing, via the model configuration manager 506, various predictive models, such as, but not limited to, machine learning models, rule-based models, and/or regressive models.

Additionally, in one or more implementations, the prompt-aware accuracy-scaling content inference system 106 utilizes the predicted input prompt load to determine approximation parameters for one or more variants of a generative model. For example, the prompt-aware accuracy-scaling content inference system 106 determines a number of generative models to operate to satisfy a predicted input load. Moreover, in one or more implementations, the prompt-aware accuracy-scaling content inference system 106 also determines an approximation level for the number of generative models to increase the speed of inferences from the generative models to satisfy the predicted input load within a threshold throughput.

For example, the prompt-aware accuracy-scaling content inference system 106 determines and configures one or more generative models at an approximation level (via approximation parameters) that speeds up generating output inferences to increase speed (or latency) of the generative model. Indeed, in one or more embodiments, the prompt-aware accuracy-scaling content inference system 106 utilizes accuracy scaling to change, via approximation parameters, an accuracy of each variant of a generative model to speed up the inferences provided by the variants of the generative model.

In one or more instances, the prompt-aware accuracy-scaling content inference system 106 utilizes modifies approximation parameters, as an accuracy scaling approach, to speed up inferences from text-to-image diffusion models. As an example, the prompt-aware accuracy-scaling content inference system 106 configures approximation parameters of a text-to-image diffusion model by configuring a number of denoising iterations to skip. Indeed, by skipping an increasing number of denoising iterations, the prompt-aware accuracy-scaling content inference system 106 speeds up generative outputs (e.g., images) from a text-to-image diffusion model. For instance, the prompt-aware accuracy-scaling content inference system 106 sets (or configures) an approximation parameter to a number of denoising iterations to skip (e.g., skipping 5 iterations, 10 iterations). By skipping denoising iterations, the prompt-aware accuracy-scaling content inference system 106 speeds up a text-to-image diffusion model because less iterations are operated by the generative model (while maintaining quality in the resulting outputs).

As an example, during a predicted low input prompt load, the prompt-aware accuracy-scaling content inference system 106 utilizes one or more generative models without (or with less) approximation level modification (e.g., without skipping denoising iterations). In addition, in one or more implementations, during a predicted high input prompt load, the prompt-aware accuracy-scaling content inference system 106 varyingly increases the approximation levels (via the approximation parameters) for the generative models to handle the high input prompt load while sustaining a throughput time (e.g., skipping denoising iterations).

In some cases, the prompt-aware accuracy-scaling content inference system 106 utilizes (or configures) approximation parameters using pre-configured settings for the generative models. For instance, the prompt-aware accuracy-scaling content inference system 106 identifies administrative settings created for the generative models and utilizes approximation levels indicated in the administrative settings to set (or configure) the approximation parameters of the generative models.

Although one or more implementations herein describe the prompt-aware accuracy-scaling content inference system 106 modifying a number of denoising iterations to skip, the prompt-aware accuracy-scaling content inference system 106 configures a variety of approximation parameters to speed up inferences at a generative model. For instance, the prompt-aware accuracy-scaling content inference system 106 configures or modifies approximation parameters by modifying parameters, such as, but not limited to, a number of layers utilizes, weight precision, learning rates, model distillation parameters, and/or model sizes.

In some instances, the prompt-aware accuracy-scaling content inference system 106 utilizes varying generative models at the different approximation parameters (or for different speeds). For instance, in some cases, the prompt-aware accuracy-scaling content inference system 106 utilizes a predicted input prompt load to determine (or load) a variety of different generative models operating at different speeds to inference serve prompts (using the prompt aware distribution mapping as described below). For instance, the prompt-aware accuracy-scaling content inference system 106 utilizes different versions of generative models (e.g., trained utilizing different approaches) to achieve the different latency speeds and routes prompts to the different generative models using a prompt aware approach in accordance with one or more implementations herein.

In some embodiments, the prompt-aware accuracy-scaling content inference system 106 utilizes varying generative model sizes for the different latency speeds. For example, in one or more instances, the prompt-aware accuracy-scaling content inference system 106 utilizes a predicted input prompt load to determine (or load) differently sized versions of a generative model (e.g., via layer pruning, distillation) to inference serve prompts (using the prompt aware distribution mapping as described below). For instance, the prompt-aware accuracy-scaling content inference system 106 utilizes the different sized generative models to achieve the different latency speeds and routes prompts to the differently sized generative models using a prompt aware approach in accordance with one or more implementations herein.

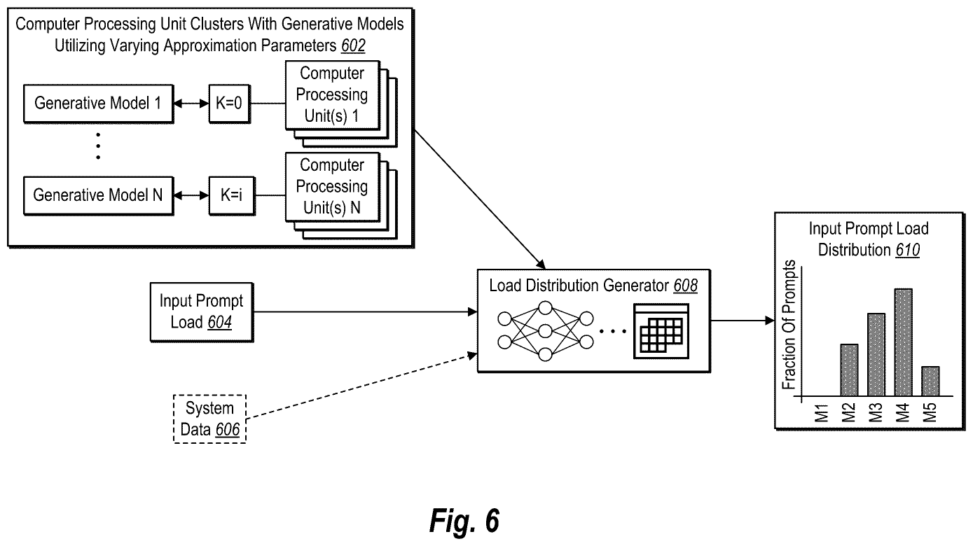

Furthermore, as mentioned above, in one or more implementations, the prompt-aware accuracy-scaling content inference system 106 determines an input prompt load distribution. For instance, FIG. 6 illustrates the prompt-aware accuracy-scaling content inference system 106 determining an input prompt load distribution. For example, as shown in FIG. 6, the prompt-aware accuracy-scaling content inference system 106 identifies a number of computer processing unit clusters with generative models utilizing varying approximation parameters 602. Indeed, as shown in FIG. 6, the prompt-aware accuracy-scaling content inference system 106 identifies generative models 1-N (e.g., variants of a generative model) configured to operate at varying approximation levels (e.g., based on approximation parameters K) at one or more computer processing unit(s) 1-N. Furthermore, as shown in FIG. 6, the prompt-aware accuracy-scaling content inference system 106 utilizes the identified number of computer processing unit clusters with generative models utilizing varying approximation parameters 602 and a predicted input prompt load 604 with a load distribution generator 608 to determine an input prompt load distribution 610.

As an example, the prompt-aware accuracy-scaling content inference system 106 generates an input prompt load distribution that indicates a fraction of prompts to utilize with variants of a generative model to satisfy a threshold throughput. For instance, the prompt-aware accuracy-scaling content inference system 106 determines a threshold throughput (e.g., via system data 606, administrator settings, a server resource controller) that indicates a number of inferences to serve within a particular time period. In addition, the prompt-aware accuracy-scaling content inference system 106 determines a distribution of fractions of input prompts to serve at the variants of generative models to achieve the threshold throughput (e.g., deciding a number of prompts to serve at slower, more accurate generative models and number of prompts to serve at faster, less accurate generative models).

Indeed, in one or more instances, the prompt-aware accuracy-scaling content inference system 106 utilizes a solver function (e.g., a mixed integer linear programming (MILP) solver) to determine an input prompt load distribution. For example, the prompt-aware accuracy-scaling content inference system 106 utilizes a MILP solver with a given system load, a fixed sized cluster of computing processing units, and a set of generative model variants (with varying inference latencies via approximation level configurations) to determine an input prompt load distribution. In particular, in one or more instances, the prompt-aware accuracy-scaling content inference system 106 utilizes the MILP solver to determine a number of instances of each generative model variant to run and what fraction of the load each must be serving to meet a throughput target (e.g., a throughput threshold).

In one or more implementations, the prompt-aware accuracy-scaling content inference system 106 identifies a set of prompt queries arriving over time as Q={q₁, . . . qₜ₋₁−1, qₜ, qₜ₊₁+1, . . . q_{T}}. In addition, in one or more instances, the prompt-aware accuracy-scaling content inference system 106 determines an expected workload (e.g., predicted input load) Wₜ in terms of Query per Minute (QPM) at time t using the past workload. For a given Wₜ, the prompt-aware accuracy-scaling content inference system 106 utilizes a MILP solver to maximize quality of inference output generation [symbol] while meeting the target workload Wₜ, for generative model variants using different approximation levels K, in accordance with the following function:

$$Maximize ℚ = {\sum }_{k} QK {\sum }_{d} xK , w \cdot {z}_{w} subject to {\sum }_{w} {z}_{w} = {W}_{t} \qquad ( 1 )$$

In the above mentioned function (1), the prompt-aware accuracy-scaling content inference system 106 utilizes a threshold throughput z_{w} (i.e., a serving throughput of a worker computing processing unit cluster w). In addition, in one or more cases, the prompt-aware accuracy-scaling content inference system 106 determines a relative inference output quality Qₖ and a peak throughput for each of the cache generative model variant (operating at an approximation level K) offline and solves the MILP at a regular interval/to determine both x_{K,w}∈{0,1} and the y_{w}∈[0,1] where x_{K} is 1 if the generative model variant at K is running at worker w and y_{w} is the fraction of prompt queries routed to worker w.

Indeed, in one or more implementations, the prompt-aware accuracy-scaling content inference system 106 utilizes the MILP-solver (in relation to function (1) above) to aggregate the fraction of requests redirected to each K as a prompt load distribution F(k) in accordance with the following function:

$$F ( k ) = \sum {x}_{K , w} {y}_{w} ∀ K , w \qquad ( 2 )$$

In the above mentioned function (2), the prompt-aware accuracy-scaling content inference system 106 generates the prompt load distribution F(k) as a distribution of queries to be assigned to each cached generative model variant with approximation levels K.

In some cases, the prompt-aware accuracy-scaling content inference system 106 determines a load distribution (or an approximation parameter configuration) as described in Ahmad et. al., Proteus: A High-Throughput Inference-Serving System with Accuracy Scaling, ASPLOS '24: Proceedings of the 29th ACM International Conference on Architectural Support for Programming Languages and Operating Systems, Volume 1 (2024), found at https://doi.org/10.1145/3617232.3624849 (hereinafter referred to as Ahmad), which is incorporated herein by reference in its entirety.

Although one or more embodiments describe the prompt-aware accuracy-scaling content inference system 106 utilizing a MILP solver to determine an input prompt load distribution, the prompt-aware accuracy-scaling content inference system 106, in one or more cases, determines the input prompt load distribution utilizing various algorithms or models. For instance, the prompt-aware accuracy-scaling content inference system 106 utilizes machine learning models (e.g., a neural network model, a transformer-based model, a regression-based model) with the (historical) input load data and/or system data to determine an input prompt load distribution and/or the approximation level configurations for the generative model variants.

As previously mentioned, the prompt-aware accuracy-scaling content inference system 106 also generates a historical prompt affinity mapping. Indeed, in one or more instances, the prompt-aware accuracy-scaling content inference system 106 utilizes affinities between cached prompts and generative model variants operating at different approximation levels (e.g., different number of skipped denoising iterations) to generate a historical prompt affinity mapping. For example, the prompt-aware accuracy-scaling content inference system 106 determines an affinity between cached prompts and generative model variants by comparing inference outputs for the cached prompts to an inference output quality threshold.

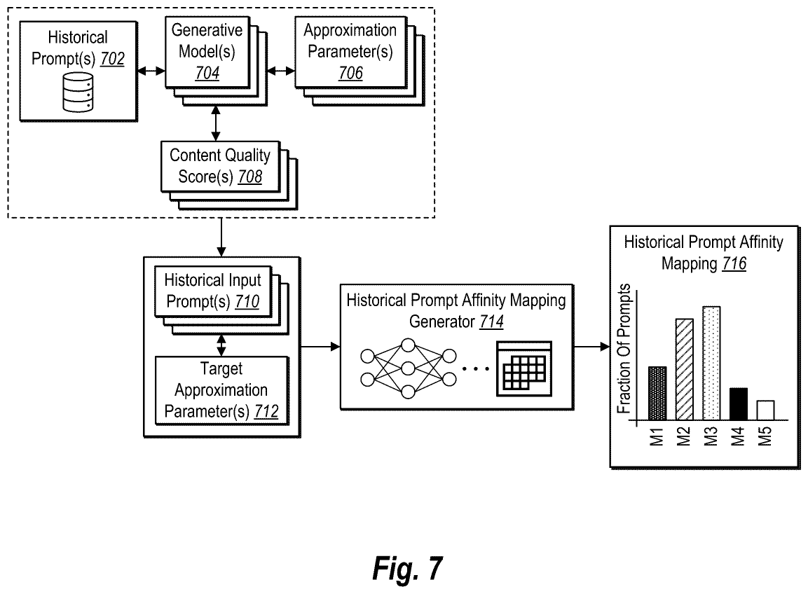

For instance, FIG. 7 illustrates the prompt-aware accuracy-scaling content inference system 106 generating a historical prompt affinity mapping. In particular, as shown in FIG. 7, the prompt-aware accuracy-scaling content inference system 106 identifies historical input prompt(s) 710 and target approximation parameter(s) 712 corresponding to the historical input prompt(s) 710 with a historical prompt affinity mapping generator 714 to generate a historical prompt affinity mapping 716.

As further shown in FIG. 7, in some cases, the prompt-aware accuracy-scaling content inference system 106 utilizes historical prompt(s) 702 with generative model(s) 704 operating with varying approximation parameter(s) 706 (e.g., approximation levels) to generate content quality score(s) 708 for outputs of the generative model(s) 704 for the historical prompt(s) 702. Indeed, in one or more cases, the prompt-aware accuracy-scaling content inference system 106 utilizes the content quality score(s) 708 to identify an approximation parameter(s) 706 for the historical prompt(s) 702 as the target approximation parameter(s) 712. For example, the prompt-aware accuracy-scaling content inference system 106 identifies a target approximation parameter for which the corresponding generative model generated an output for the historical prompt having a content quality score that meets or satisfies an inference output quality threshold.

In some cases, the prompt-aware accuracy-scaling content inference system 106 identifies historical input prompts with mapped target approximation parameters from a mapped library of historical input prompts. In particular, in one or more cases, the mapped library of historical input prompts includes pre-determined mappings between historical input prompts and target approximation levels to utilize for the historical input prompts (based an inference output quality threshold). Indeed, in one or more cases, the prompt-aware accuracy-scaling content inference system 106 utilizes the pre-mapped historical input prompts (and corresponding target approximation parameters) to generate a historical prompt affinity mapping.

Furthermore, in one or more cases, the prompt-aware accuracy-scaling content inference system 106 utilizes content quality scores to generate historical prompt affinities. For example, the prompt-aware accuracy-scaling content inference system 106 utilizes a prompt-to-approximation level determination (or prompt-to-K model) to determine the historical prompt affinities. For example, the prompt-aware accuracy-scaling content inference system 106 utilizes a prompt-to-approximation level determination by identifying N variants of a generative model (e.g., text-to-image diffusion models), {M₁, . . . , M_{N}}. Moreover, in one or more cases, for a cached (or historical) prompt P, the prompt-aware accuracy-scaling content inference system 106 determines a quality of content output (e.g., image quality) generated by each of the generative model variants, {q₁, . . . , q_{N}}. Furthermore, in one or more cases, the prompt-aware accuracy-scaling content inference system 106 identifies a target quality (e.g., an optimal quality) output for the prompt P in accordance with the following function:

$${q}_{i} > δ \times max ( {q}_{1} , … , {q}_{N} \} \qquad ( 3 )$$

In the above mentioned function (3), in one or more embodiments, the prompt-aware accuracy-scaling content inference system 106 utilizes an inference output quality threshold & to determine the target quality. For instance, the prompt-aware accuracy-scaling content inference system 106 determines a content output quality qᵢ as the best quality content output (e.g., max) that also is within a threshold value of the inference output quality threshold & (e.g., 90%, 85%, 70%). Moreover, in one or more cases, the prompt-aware accuracy-scaling content inference system 106 determines an affinity between a generative model variant operating at a particular approximation level and the historical prompt by identifying a target approximation parameter for a variant of a generative model that results in a target content output quality qᵢ (in relation to function (3)) while also minimizing an amount of inference time (e.g., having the least amount of inference time from the generative model variants that satisfy the inference output quality threshold δ).

In some cases, the prompt-aware accuracy-scaling content inference system 106 utilizes a measure of content output quality as described in Kirstain et. al., Pick-a-Pic: An Open Dataset of User Preferences for Text-To-Image Generation, arXiv: 2305.01569 (2023) (hereinafter referred to as Kirstain), which is incorporated herein by reference in its entirety. Furthermore, in one or more instances, the prompt-aware accuracy-scaling content inference system 106 utilizes a prompt-to-approximation level determination (or prompt-to-K model) as described in Agarwal et. al., Approximate Caching for Efficiently Serving Diffusion Models, arXiv:2312.04429 (2023) (hereinafter referred to as Agarwal), which is incorporated herein by reference in its entirety.

Moreover, in one or more instances, the prompt-aware accuracy-scaling content inference system 106 utilizes the historical prompt affinities between the historical prompts and generative model variants to generate a historical prompt affinity mapping. In some instances, the generates the historical prompt affinity mapping as a prompt-affinity histogram (as shown in FIGS. 4, 7, and 9) that represents generative model variants and a fraction of prompts (from the historical prompts) mapping to the generative model variants. Indeed, in one or more instances, the prompt-aware accuracy-scaling content inference system 106 utilizes the prompt-affinity histogram to represent a distribution of how historical prompts map to generative model variants having different approximation levels based on the affinities determined between the historical prompts and the generative model variants (as described above).

Although one or more embodiments describe the prompt-aware accuracy-scaling content inference system 106 generating a historical prompt affinity mapping as a prompt-affinity histogram, the prompt-aware accuracy-scaling content inference system 106, in one or more implementations, generates a historical prompt affinity mapping utilizing a various data representations, such as, but not limited to, a matrix mapping, a tree diagrams, relational databases, and/or tagging or labeling historical prompts with target approximation parameters.

As previously mentioned, in one or more implementations, the prompt-aware accuracy-scaling content inference system 106 generates a prompt distribution mapping. In particular, in one or more instances, the prompt-aware accuracy-scaling content inference system 106 generates a prompt distribution mapping that indicates a redirection probability for an input prompt (based a load circumstance as determined by the historical prompt affinity mapping and the prompt distribution load). For instance, in some cases, the historical prompt affinity mapping and the prompt distribution load may differ. In response, in one or more implementations, the prompt-aware accuracy-scaling content inference system 106 generates the prompt distribution mapping to align the historical prompt affinity mapping and the prompt distribution load through redirection probabilities.

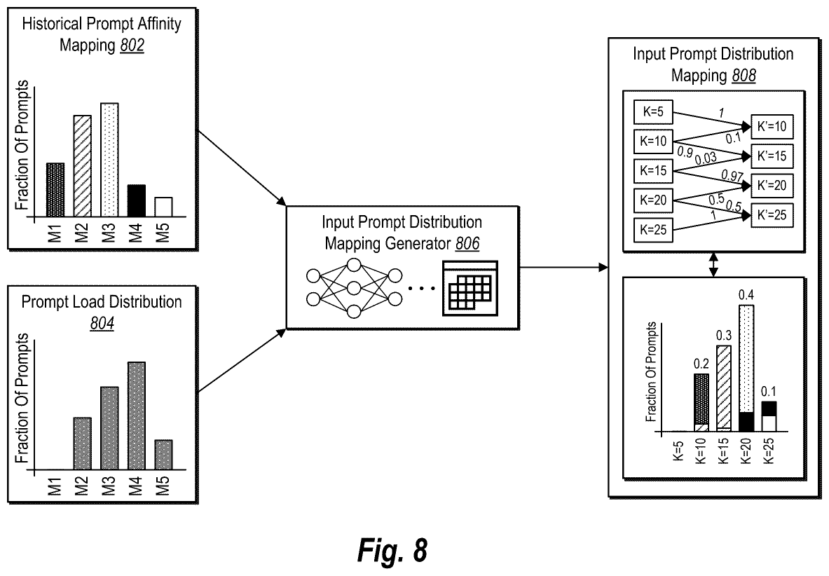

For instance, FIG. 8, illustrates the prompt-aware accuracy-scaling content inference system 106 generating a prompt distribution mapping. Indeed, as shown in FIG. 8, the prompt-aware accuracy-scaling content inference system 106 utilizes a historical prompt affinity mapping 802 (generated in accordance with one or more implementations herein) and a prompt load distribution 804 (generated in accordance with one or more implementations herein) with an input prompt distribution mapping generator 806 to generate an input prompt distribution mapping 808. For instance, as shown in FIG. 8, in some cases, the prompt-aware accuracy-scaling content inference system 106 generates the input prompt distribution mapping 808 as a shift graph that determines prompt shift probabilities that indicate redirection probabilities for historical prompts based on target approximation parameters of the historical prompts from the historical prompt affinity mapping 802 fitting the prompt load distribution 804.

As an example, in some cases, the prompt-aware accuracy-scaling content inference system 106 utilizes, as the input prompt distribution mapping generator 806, a prompt distribution aligner to determine redirection probabilities (captured as a shift graph SG). In particular, in one or more implementations, for an incoming prompt with an assigned approximation parameter K (determined using an affinity to a cached prompt with a target approximation parameter and/or using an prompt-to-approximation parameter determination as described above), the prompt-aware accuracy-scaling content inference system 106 determines a redirected approximation parameter K′ (e.g., an appropriate alternate value of K) to utilize for the incoming prompt in the present load situation (as determined by the prompt load distribution and the historical prompt affinity mapping).

Indeed, in one or more instances, the prompt-aware accuracy-scaling content inference system 106 utilizes the generated shift graph (e.g., input prompt distribution mapping) to shift queries to a slower (more accurate) model running at a redirected approximation parameter (e.g., K′ st K′<K). In some instances, the prompt-aware accuracy-scaling content inference system 106 utilizes the generated shift graph SG (e.g., input prompt distribution mapping) to shift queries to the closest available faster generative model running at a redirected approximation parameter (e.g., K′ st K′>K). The prompt-aware accuracy-scaling content inference system 106 shifts queries using the shift graph SG while minimizing the overall inference output content quality degradation [symbol] _{Q}.

As an example, the prompt-aware accuracy-scaling content inference system 106 generates a shift graph SG as P (i.e., an input prompt distribution mapping) using a historical prompt affinity mapping H(k) and a prompt distribution load F(k) in accordance with the following Algorithm 1.

```
Algorithm 1
Initialize H_{old} ← Hₖ, P ← { }
for kᵢ in {25, 20, ... , 5) do
  if Hₖ(kᵢ) > Fₖ(kᵢ) then
    $P ( {K}_{( i - 1 )} \vert {k}_{i} ) ← \frac{{H}_{k} ( {k}_{i} ) - {F}_{k} ( {k}_{i} )}{{H}_{k} ( {k}_{i} )}$
    Hₖ(kᵢ₋₁) ← Hₖ(kᵢ₋₁) + Hₖ(kᵢ) − Fₖ(kᵢ)
    Hₖ(kᵢ) ← Fₖ(kᵢ)
  else
    while Hₖ (kᵢ) < Fₖ(kᵢ) do
      for all j ∈ {1, 2, ... } do
        shift_{(i,j)} ← min(Hₖ(kᵢ₋ⱼ), Fₖ(kᵢ) − Hₖ(kᵢ))
        $P ( {k}_{i} \vert {k}_{( i - j )} ) ← \frac{shift ( i , j )}{{H}_{old} ( {k}_{( i - j} )}$
        Hₖ(k(ᵢ₋ⱼ) ← Hₖ(k₍ᵢ₋ⱼ₎) − shift_{(i,j)}
        Hₖ(k₍ᵢ₎) ← Hₖ (k₍ᵢ₎) + shift_{(i,j)}
        $P ( {k}_{( i - j )} \vert {k}_{( i - j )} ) ← \frac{{H}_{k} ( {k}_{i - j} )}{{H}_{old} ( {k}_{( i - j} )}$
      end for
    end while
  end if
end for
return P {P serves as the Shift Graph SG}
```

In addition, in one or more instances, the prompt-aware accuracy-scaling content inference system 106 generates the shift graph SG (as the input prompt distribution mapping) by determining a probability of shift to produce a shift graph while minimizing an overall inference output quality degradation in accordance with the following function:

$$Minimize {𝔻}_{Q} = {\sum }_{i} {\sum }_{j s . t . {K}_{j}^{′} > {K}_{i}} P ( {K}_{j}^{′} \vert {K}_{i} ) \cdot {H}_{k} ( {K}_{i} ) \cdot 𝒟 ( {K}_{j}^{′} - {K}_{i} ) \qquad ( 4 )$$

In one or more implementations, the prompt-aware accuracy-scaling content inference system 106 utilizes the Algorithm 1 (and function (4)) to iterate over K (e.g., from larger K values to smaller K values) to compare the corresponding K positions in a historical prompt affinity mapping Hₖ and a prompt load distribution Fₖ. For example, if Hₖ is greater than Fₖ, the prompt-aware accuracy-scaling content inference system 106 determines that there are more prompts which associate with K as optimal K (e.g., as an assigned or target approximation level) than what is able to be served by existing computer processing unit cluster(s) (e.g., workers) running generative model variants at the approximation level of K. In response to Hₖ being greater than FR for the approximation level of K, in one or more instances, the prompt-aware accuracy-scaling content inference system 106 shifts the prompts to the immediately left bar (e.g., Kᵢ₋₁).

In addition, in one or more cases, the prompt-aware accuracy-scaling content inference system 106 determines that there are less prompts than what is able to be served by existing computer processing unit cluster(s) (e.g., workers) running generative model variants at the approximation level of K (e.g., Hₖ being lesser than Fₖ). In response to Hₖ being lesser than Fₖ, in one or more instances, the prompt-aware accuracy-scaling content inference system 106 shifts a number of prompts to fill a gap from the immediate left (e.g., shift(i, j) in Algorithm 1) to make room for other generative models with approximation levels that have more prompts than allocated.

Furthermore, in one or more instances, the prompt-aware accuracy-scaling content inference system 106, at each step (in relation to Algorithm 1 and function (4)), computes a probability using a fraction of shift divided by the total number of approximation levels K (e.g., P(K₍ᵢ₋₁₎|kᵢ) and/or

$$P ( {k}_{( i - j )} \vert {k}_{( i - j )} ) ← \frac{{H}_{k} ( {k}_{i - j} )}{{H}_{old} ( {k}_{( i - j )} )}$$

in Algorithm 1). In one or more instances, the prompt-aware accuracy-scaling content inference system 106 continuously repeats the process for each approximation level until gaps are filled in the shift graph. In addition, in one or more implementations, the prompt-aware accuracy-scaling content inference system 106 computes or generates one or more transition probabilities using the step probabilities obtained to get the transition shift graph SG (e.g., in Algorithm 1 and function (4)). Indeed, in one or more cases, the prompt-aware accuracy-scaling content inference system 106 computes or generates transition probabilities in accordance with the following function:

$$P ( {K}_{j}^{′} \vert {K}_{i} ) = P ( {K}_{j}^{′} \vert {K}_{j - 1}^{′} ) … P ( {K}_{j - n + 1}^{′} \vert {K}_{j - n}^{′} ) \cdot P ( {K}_{j - n}^{′} \vert {K}_{i} ) \qquad ( 5 )$$

Although one or more embodiments describe the prompt-aware accuracy-scaling content inference system 106 utilizing a distribution alignment algorithm to generate the input prompt distribution mapping, in some cases, the prompt-aware accuracy-scaling content inference system 106 utilizes a variety of models to generate the input prompt distribution mapping. For instance, prompt-aware accuracy-scaling content inference system 106 inputs a historical prompt affinity mapping and a prompt load distribution into a deep machine learning model (e.g., a neural network, a transformer-based network, classifier) to enable the deep machine learning model to analyze the historical prompt affinity mapping and the prompt load distribution to determine and generate an input prompt distribution mapping. In some cases, the prompt-aware accuracy-scaling content inference system 106 utilizes an earth mover's distance (EMD) algorithm to generate the input prompt distribution mapping.

As mentioned above, in one or more implementations, the prompt-aware accuracy-scaling content inference system 106 selects, based on an input prompt distribution mapping, a generative model for an input prompt to generate an inference output. For instance, the prompt-aware accuracy-scaling content inference system 106 selects a generative model variant for an incoming input prompt (to serve an inference output) by utilizing the prompt distribution mapping and an approximation parameter assigned to the input prompt. For example, the prompt-aware accuracy-scaling content inference system 106 determines an approximation parameter assignment for the input prompt (e.g., using a prompt-to-approximation level determination). Additionally, in one or more implementations, the prompt-aware accuracy-scaling content inference system determines affinities between the input prompt and a historical prompt associated with a target approximation value. Moreover, in one or more implementations, the prompt-aware accuracy-scaling content inference system utilizes the prompt distribution mapping to select an available generative model variant with an approximation level that best matches to the target approximation level assigned to the particular input prompt.

For instance, FIG. 9 illustrates the prompt-aware accuracy-scaling content inference system 106 selecting a generative model to generate an inference output for an input prompt utilizing an input prompt distribution mapping. In particular, as shown in FIG. 9, the prompt-aware accuracy-scaling content inference system 106 receives an input prompt P_{Q}. Moreover, as shown in FIG. 9, the prompt-aware accuracy-scaling content inference system 106 utilizes an embedding generator 904 to generate a prompt embedding eₚ for the input prompt P_{Q}. In addition, as shown in FIG. 9, the prompt-aware accuracy-scaling content inference system 106 utilizes the prompt embedding eₚ with a prompt-to-k-model 906 to identify a cached prompt P_{C} (and an image quality score M_{score}) for the prompt embedding eₚ (from a query prompt database 908). In some cases, the prompt-aware accuracy-scaling content inference system 106 utilizes a cached prompt P_{C} having an embedding that matches the prompt embedding eₚ (e.g., via a similarity score s). Indeed, as shown in FIG. 9, the prompt-aware accuracy-scaling content inference system 106 identifies a target approximation parameter corresponding to the matched cached prompt P_{C} to utilize as the approximation parameter assignment K for the input prompt P_{Q}. In one or more instances, a prompt-to-k-model includes a prompt-to-approximation level determination model as described above (e.g., in relation to FIG. 7).

Furthermore, as shown in FIG. 9, the prompt-aware accuracy-scaling content inference system 106 utilizes a K-to-K′ mapper 910 to determine a redirected approximation parameter K′ for the input prompt P_{Q} using the approximation parameter assignment K and the input prompt distribution mapping 902. For example, the redirected approximation parameter K′ includes an approximation parameter determined for the input prompt P_{Q} based the redirection probability that accounts for an input load circumstance determined by the input prompt distribution mapping 902.

Moreover, as shown in FIG. 9, the prompt-aware accuracy-scaling content inference system 106 utilizes the redirected approximation parameter K′ to select a generative model variant to inference serve the input prompt P_{Q}. For instance, as shown in FIG. 9, the prompt-aware accuracy-scaling content inference system 106 utilizes a generative model selector 912 to select a generative model variant that corresponds to the redirected approximation parameter K′ operating on a particular computer processing unit cluster (e.g., GPU₀ to GPUᵢ). Moreover, the prompt-aware accuracy-scaling content inference system 106 utilizes the cached prompt P_{C} with a noise retriever 914 to retrieve noise corresponding to a denoising iteration for the cached prompt P_{C} at the approximation level of K′. Indeed, in one or more cases, the prompt-aware accuracy-scaling content inference system 106 retrieves the noise from a cached prompt noise repository 916 that includes cached inferences and prompts for the particular generative model variants at different approximation levels. Moreover, as shown in FIG. 9, the prompt-aware accuracy-scaling content inference system 106 utilizes the retrieved noise and the generative model variant (e.g., text-to-image model 918) to generate an output inference image 920 from the retrieved noise from the noise retriever 914 at a skipped denoising iteration determined by the redirected approximation parameter K′ for the input prompt P_{Q}.

In some embodiments, the prompt-aware accuracy-scaling content inference system 106 utilizes a scheduler to receive an input prompt P_{Q} and routes it to an appropriate generative model variant (e.g., an approximate caching generative model) running at an approximation level K on a computer processing unit cluster (e.g., GPU workers). For instance, the prompt-aware accuracy-scaling content inference system 106 determines an embedding vector eₚ for the input prompt (e.g., a CLIP embedding vector, a deep learning embedding). Moreover, in one or more instances, the prompt-aware accuracy-scaling content inference system 106 utilizes the embedding vector eₚ to identify, from a cached input prompt data base, a nearest caches prompt P_{c}, and uses the similarity score s, to determine a target approximation parameter K for the input prompt (using a prompt-to-approximation level determination as described above).

Moreover, given an incoming prompt, the matching cached prompt, and the target approximation parameter, in one or more instances, the prompt-aware accuracy-scaling content inference system 106 utilizes the K-to-K′ mapper to select a final (or redirected) approximate model at K′ for the input prompt by using a shift graph (SG), generated in accordance with one or more implementations herein, such that a throughput is able to meet a current workload with a while minimizing a quality degradation (e.g., least quality degradation).

As an example, the prompt-aware accuracy-scaling content inference system 106 determines utilizing a shift graph corresponding to the input prompt distribution mapping that a generative model variant operating at a target approximation level for the input prompt is not available (e.g., for meeting the fraction of prompts directed to the generative model variant). In response, the prompt-aware accuracy-scaling content inference system 106 identifies another approximation level for the input prompt based on the input prompt distribution mapping. For instance, the prompt-aware accuracy-scaling content inference system 106 determines a shift down in an approximation level (e.g., the subsequent approximation level that skips less denoising iterations) when the target approximation level is not available. In some instances, the prompt-aware accuracy-scaling content inference system 106 determines a shift up in an approximation level (e.g., a subsequent approximation level that skips more denoising iterations) when the more accurate approximation levels are not available. Indeed, in one or more cases, the prompt-aware accuracy-scaling content inference system 106 identifies an alternative approximation level for the input prompt that generates an inference output for the input prompt at a quality score that satisfies a threshold quality score.

In some cases, the prompt-aware accuracy-scaling content inference system 106 determines, via the K-to-K′ mapper, that the target approximation level is available for the input prompt via the input prompt distribution mapping. In response, the prompt-aware accuracy-scaling content inference system 106, in one or more instances, utilizes a generative model with the target approximation level to serve an inference for the input prompt.

In some cases, the prompt-aware accuracy-scaling content inference system 106 generates an embedding vector for the input prompt as described in Radford, et. al., Learning Transferable Visual Models from Natural Language Supervision, International Conference on Machine Learning, pages 8748-8763 (2021), which is incorporated herein by reference in its entirety.

In one or more instances, the prompt-aware accuracy-scaling content inference system 106 utilizes approximate caching to generate an inference output using retrieved noise from a cached prompt (that is similar to the input prompt) at an approximation level (determined as described above). Indeed, in some cases, the prompt-aware accuracy-scaling content inference system 106 utilizes approximate caching as described in Agarwal.

Furthermore, in one or more cases, the prompt-aware accuracy-scaling content inference system 106 utilizes, as the cached prompt noise repository 916, a vector database (VDB) which stores intermediate states (through prompt embedding vectors for indexing).

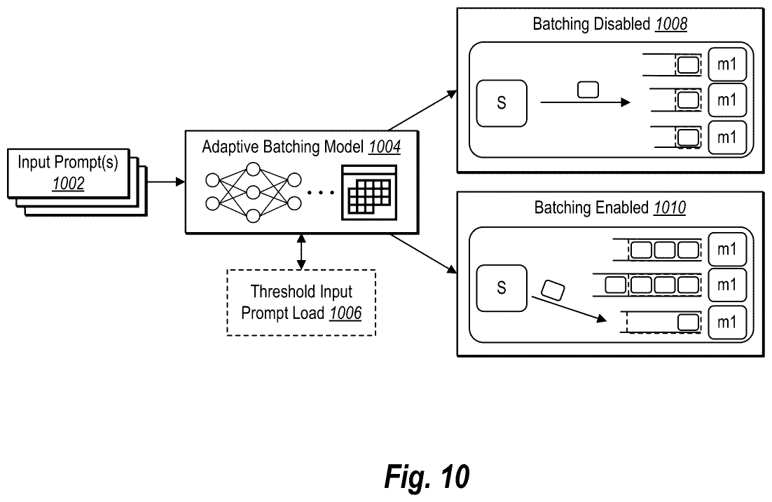

In addition, in one or more embodiments, the prompt-aware accuracy-scaling content inference system 106 utilizes load aware routing and/or adaptive batching with the prompt aware selection of approximation levels for generative models. For instance, FIG. 10 illustrates the prompt-aware accuracy-scaling content inference system 106 utilizing load aware routing and/or adaptive batching to provide prompts to computer processing unit workers based on a low-load and high-load condition. In addition, one or more instances, the prompt-aware accuracy-scaling content inference system 106 also adaptively enables batching while inference serving input prompts through one or more generative model variants (in accordance with one or more implementations herein). As shown in FIG. 10, the prompt-aware accuracy-scaling content inference system 106 receives input prompt(s) 1002 and utilizes an adaptive batching model 1004 to determine whether to utilize batching for the input prompt(s) 1002 and also to route prompts based on load condition. In some cases, the prompt-aware accuracy-scaling content inference system 106 determines whether to utilize batching and a routing approach by utilizing the input prompt(s) 1002 (to determine an input load) and a threshold input prompt load 1006 (that triggers the batching of input prompts).

As further shown in FIG. 10, the prompt-aware accuracy-scaling content inference system 106, upon determining to disable batching (e.g., batching disabled 1008) for the input prompt(s) 1002, schedules(S) the input prompts into a generative model variant (m1) (in accordance with one or more implementations herein) utilizing uniform routing (e.g., sending single prompts for inference serving at each of the generative model variants). As further shown in FIG. 10, the prompt-aware accuracy-scaling content inference system 106, upon determining to enable batching (e.g., batching enabled 1010) for the input prompt(s) 1002, schedules(S) the input prompts into a generative model variant (m1) (in accordance with one or more implementations herein) utilizing a batching routing process to batch process multiple input prompts at each of the generative model variants. For example, the prompt-aware accuracy-scaling content inference system 106 utilizes batching approaches, such as, but not limited to, greedy routing.

In one or more instances, the prompt-aware accuracy-scaling content inference system 106 determines to disable and/or enable batching utilizing a determined load size. For instance, the prompt-aware accuracy-scaling content inference system 106 utilizes a load size (of the input prompt(s) 1002) in comparison to a threshold input prompt load 1006 to determine whether there is a high load (e.g., meets or satisfies the threshold input prompt load 1006) or a low load (e.g., does not meet or satisfy the threshold input prompt load 1006). Indeed, in one or more instances, the prompt-aware accuracy-scaling content inference system 106 enables batching upon detecting a high load and disables batching upon detecting a low load.

Furthermore, the prompt-aware accuracy-scaling content inference system 106 also utilizes load-aware routing to cause a scheduler to switch between uniform and greedy routing based on a load condition. During uniform routing, an incoming input prompt (or query), with a determined target approximation parameter K′ (determined as described above), is uniform randomly distributed across all computer processing units (GPUs) running at the approximation level of K′. In one or more instances, during a low load condition, the prompt-aware accuracy-scaling content inference system 106 utilizes uniform routing with batching disabled to result in prompts being processed as quickly as they arrive.

In addition, in one or more instances, the prompt-aware accuracy-scaling content inference system 106, during high-load conditions, utilizes greedy routing. In particular, in one or more implementations, the prompt-aware accuracy-scaling content inference system 106 utilizes greedy routing to cause the scheduler to greedily place a prompt (or query), with a determined target approximation parameter K′ (determined as described above), on a computer processing unit cluster (e.g., one or more GPUs) that has the longest queue length. Indeed, in one or more cases, the prompt-aware accuracy-scaling content inference system 106 utilizes greedy routing to maximize the chance for GPU workers that switch to adaptive batching under a high-load, to use optimal batch-size during inference and maximize a throughput.

In one or more instances, the prompt-aware accuracy-scaling content inference system 106 utilizes computer processing unit clusters (e.g., as workers) that run the same generative model (e.g., an image-to-text diffusion model) at different Ks of approximation (for approximate caching). In one or more implementations, the prompt-aware accuracy-scaling content inference system 106 also utilizes batching with a batch size B that is dynamically determined based on error rates of the prompts (e.g., SLO) and/or a latency versus batch-size model corresponding to each approximation level variant of the generative model (e.g., the adaptive batching model 1004). During batching, in one or more cases, the prompt-aware accuracy-scaling content inference system 106 utilizes the computer processing unit clusters to make a parallel call to retrieve B intermediate-states (or noises) corresponding to the approximation level of K for the computer processing unit clusters (e.g., for multiple prompts) in accordance with one or more implementations herein. Moreover, in one or more instances, the B noises include intermediate steps previously generated for cached prompts that correspond to each of the B input prompts in the batch (in accordance with one or more implementations herein). Using the retrieved B noises, the prompt-aware accuracy-scaling content inference system 106, in one or more implementations, generates B output images conditioned by the input prompts utilizing an inference step of the generative model (e.g., a text-to-image model) which internally makes N−K denoising steps for each batch of prompts.

In one or more cases, batching impacts inference speeds of generative models. To improve high throughput, in one or more instances, the prompt-aware accuracy-scaling content inference system 106 utilizes batching in specific instances that improve throughput while avoiding unnecessarily causing low-speed inferencing from batching by utilizing adaptive batching. For instance, for a given target generative model (e.g., a diffusion model), the prompt-aware accuracy-scaling content inference system 106 models a speed up in inference (S (b)) as a function of a batch size b. In addition, in one or more instances, the prompt-aware accuracy-scaling content inference system 106 determines a point at which a batch-size saturates (e.g., begins to not (significantly) increase inference latency) as (bₒₚₜ, sₒₚₜ). In one or more implementations, the prompt-aware accuracy-scaling content inference system 106 utilizes a straight line analytical model for speed-up in accordance with the following function:

$$S ( b ) ( 1 - {b}_{opt} ) = b ( 1 - {s}_{opt} ) + {s}_{opt} - {b}_{opt} \qquad ( 6 )$$

In one or more embodiments, the prompt-aware accuracy-scaling content inference system 106 maintains a batch size as lesser than bₒₚₜ. In addition, to avoid SLO violations of the prompts (or queries) while waiting in a queue, the prompt-aware accuracy-scaling content inference system 106, in one or more cases, maintains a head of the line (HOTL) query along with the time to process batch size of b that remains within a latency SLO threshold (e.g., within a latency time threshold). For example, for an inference latency L with a batch size of 1 for a generative model and a current wait time of HOTL of T_{wait}, prompt-aware accuracy-scaling content inference system 106 maximizes b subject to the following function:

$${T}_{wait} + f ( b ) < {T}_{SLO} where f ( b ) = \frac{b \cdot L}{S ( b )} \qquad ( 7 )$$

As a result of the above mentioned function (7), in one or more instances, the prompt-aware accuracy-scaling content inference system 106 results in a queue with sufficient prompts (or queries) to create a batch b as large as bₒₚₜ (e.g., an optimal batch size) while remaining within a latency SLO threshold. In one or more instances, during high-load condition (as shown in FIG. 10), the prompt-aware accuracy-scaling content inference system 106 enables batching with the dynamic optimum b as described above. In some cases, the prompt-aware accuracy-scaling content inference system 106 results in a few prompts (or queries) and waits in a non-work-conserving approach until the inequality of function (7) holds, or more prompts arrive in the queue. Moreover, in one or more implementations, during a low-load condition (as shown in FIG. 10), the prompt-aware accuracy-scaling content inference system 106 disables batching by utilizing b=1 (in relation to the function (7)).

Moreover, in one or more implementations, the prompt-aware accuracy-scaling content inference system 106 further utilizes horizontal scaling or model-level autoscaling while accuracy-scaling and prompt micromanaging (in accordance with one or more implementations herein) to increase the number of workers and model instances to handle a load increase. In addition, in one or more embodiments, the prompt-aware accuracy-scaling content inference system 106 also utilizes techniques, such as, but not limited to, distillation, pruning, sparsification, quantization to provide additional variants for accuracy-scaling and prompt micromanaging (in accordance with one or more implementations herein).

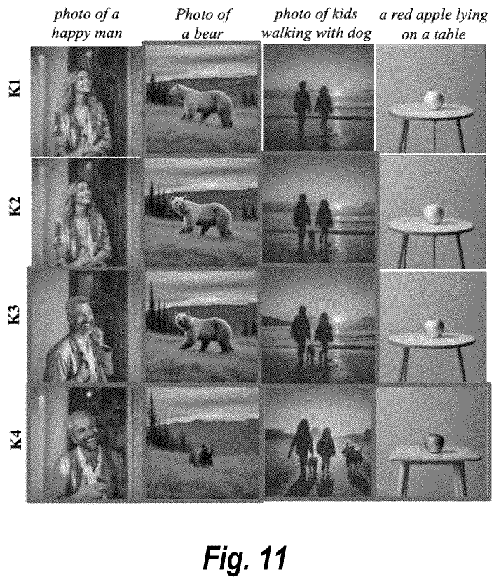

Experimenters utilized an implementation of the prompt-aware accuracy-scaling content inference system to generate digital images from variants (approximation levels K) of a diffusion model for different prompts. Indeed, the implementation of the prompt-aware accuracy-scaling content inference system was able to use prompt awareness to generate images for the prompt set using smaller variants (e.g., higher K approximation levels) with increased speed. Indeed, FIG. 11 illustrates image outputs for various prompts using an implementation of the prompt-aware accuracy-scaling content inference system in which smaller variants (e.g., higher K approximation levels) of the diffusion model were able to generate accurate images for prompts with increased speed. Indeed, in reference to FIG. 11, the implementation of the prompt-aware accuracy-scaling content inference system resulted in the following PickScores (e.g., as described in Kirstain), where certain faster generative model variants (e.g., K1, K2, K3, K4) are similar in quality to slower (less approximated) models for the set of prompts (e.g., P1, P2, P3, P4).

TABLE 1

| | P1 | P2 | P3 | P4 |
|---|---|---|---|---|
| K1 | 19.98 | 21.17 | 21.88 | 21.25 |
| K2 | 19.87 | 21.54 | 23.19 | 21.34 |
| K3 | 22.25 | 21.80 | 23.31 | 21.61 |
| K4 | 22.32 | 21.97 | 23.54 | 22.54 |

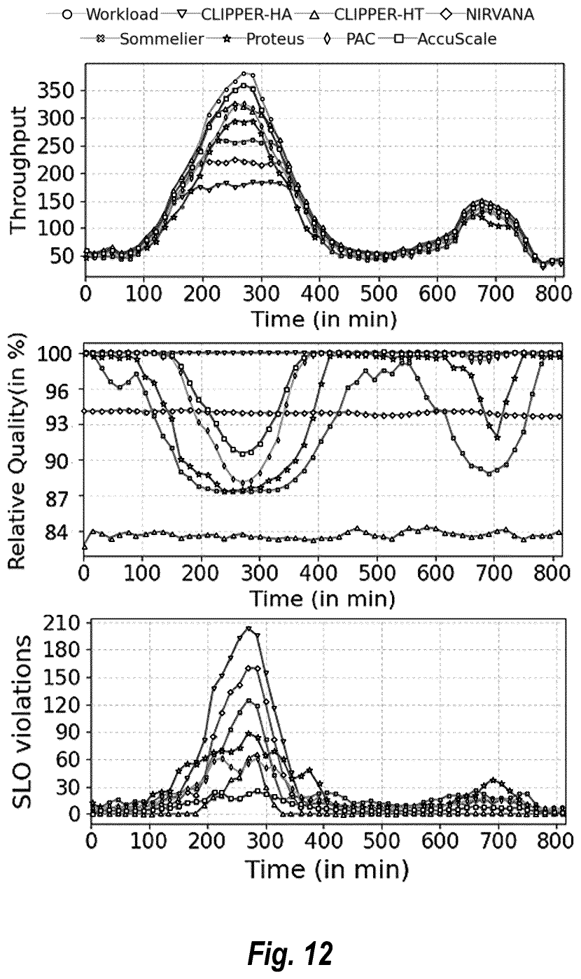

In addition, the Experimenters also evaluated an implementation of the prompt-aware accuracy-scaling content inference system (AccuScale) against several baselines on system throughput, quality of generation (accuracy) and SLO violations. Moreover, the Experimenters also conducted ablation studies on an implementation of the prompt-aware accuracy-scaling content inference system (AccuScale) to demonstrate the impact of various components of the prompt-aware accuracy-scaling content inference system. FIGS. 12-18 illustrate results from the evaluations and ablation studies of an implementation of the prompt-aware accuracy-scaling content inference system.

For instance, the Experimenters used an implementation of prompt-aware accuracy-scaling content inference system, AccuScale. In addition, the Experimenters used various baselines for the evaluation, such as a prompt-agnostic version of AccuScale (PAC) which does not use prompt-aware allocation, Proteus as described in Ahmad, Clipper-HA and Clipper-HT as described in Daniel Crankshaw et. al., Clipper: A {Low-Latency} Online Prediction Serving System, 14th USENIX Symposium on Networked Systems Design and Implementation, pages 613-627 (2017), Sommelier as described in Peizhen Guo et. al., Sommelier: Curating DNN Models for the Masses, Proceedings of the 2022 International Conference on Management of Data, pages 1876-1890 (2022), and NIRVANA as described in Agarwal. Indeed, the evaluations utilize the implementation of the prompt-aware accuracy-scaling content inference system (AccuScale) and the above-mentioned baselines using a combination of production and synthetic workloads, aiming to capture both real-world and a variety of specific patterns. For instance, to capture realistic system loads (measured as queries per second QPS), the experimenters used Twitter traces collected over a month. Furthermore, the Experimenters used QPS patterns from a text-to-image service trace from SysX (SysX trace). In addition, the Experimenters created a bursty synthetic workload featured with interleaved periods of low and high query demand (generated through a Poisson process) for query inter-arrivals to introduce macro-scale bursts.

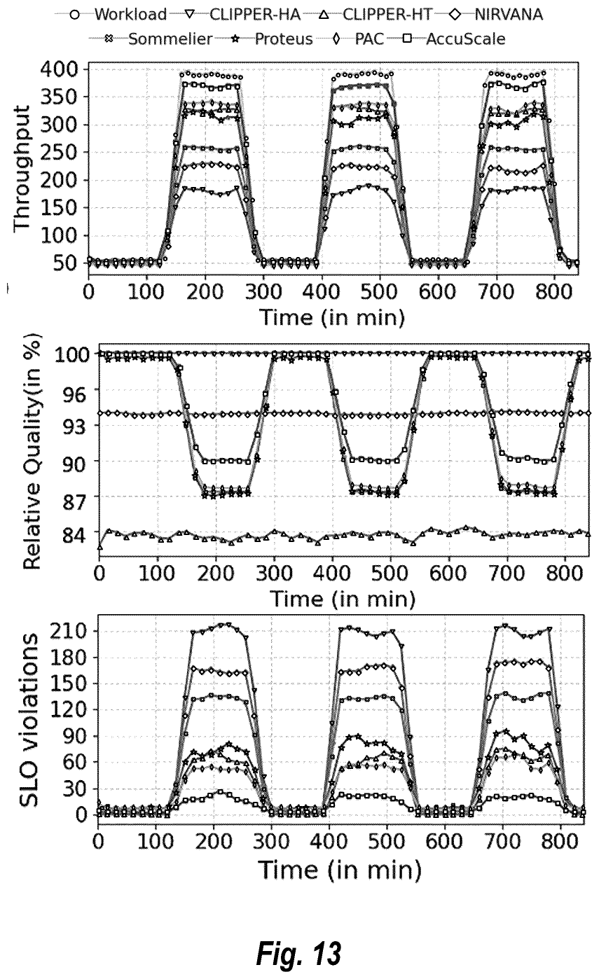

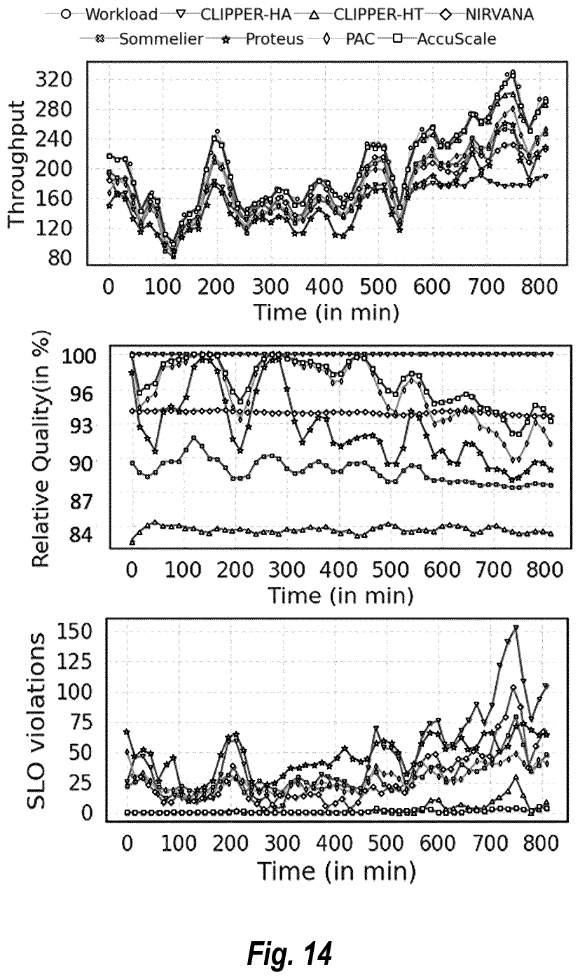

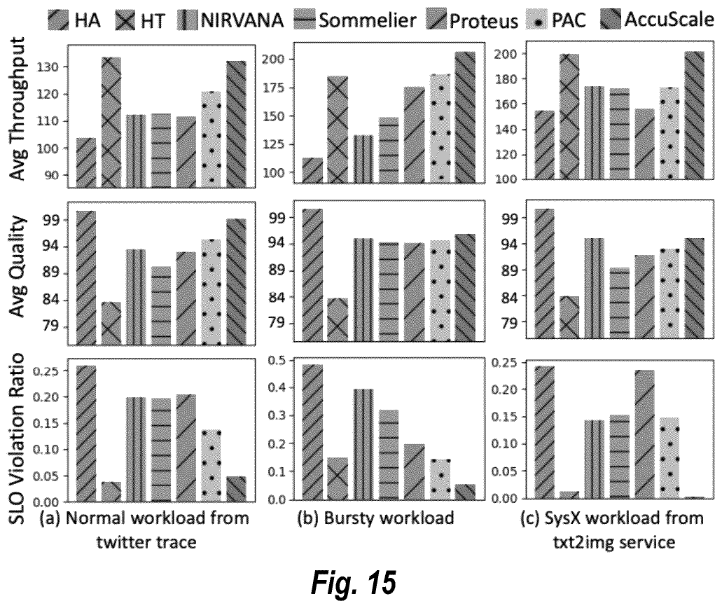

For example, FIG. 12 illustrates the results of AccuScale and the other baseline models under the Twitter trace workload. Furthermore, FIG. 13 illustrates the results of AccuScale and the other baseline models under the bursty synthetic workload. Lastly, FIG. 14 illustrates the results of AccuScale and the other baseline models under the under the SysX trace workload. As shown in FIGS. 12-14, AccuScale consistently resulted in the lowest drop in relative quality and the lowest SLO violation ratio amongst the baseline approaches while also meeting the incoming load (e.g., handling the throughput) under the various workloads. Indeed, as shown in FIG. 15, the implementation of the prompt-aware accuracy-scaling content inference system (AccuScale) outperforms the other baseline approaches with a higher average quality, lower SLO violations, and a higher throughput.

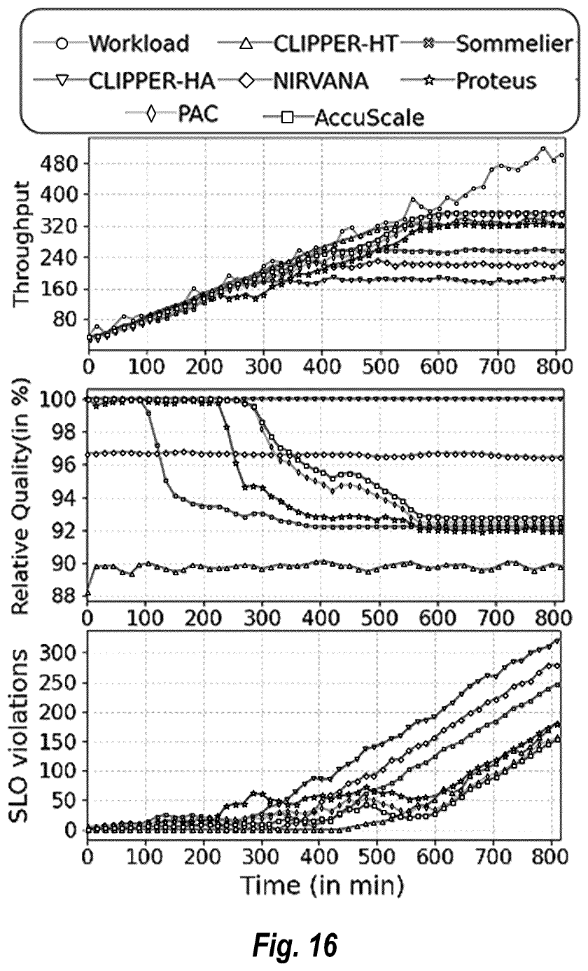

Moreover, as shown in FIG. 16, during a stress test (e.g., to an extremely high load of 540 queries per minute), the implementation of the prompt-aware accuracy-scaling content inference system (AccuScale) offers the highest throughput and the lowest SLO violations at a relatively high generation quality (accuracy) compared to the other baseline approaches.

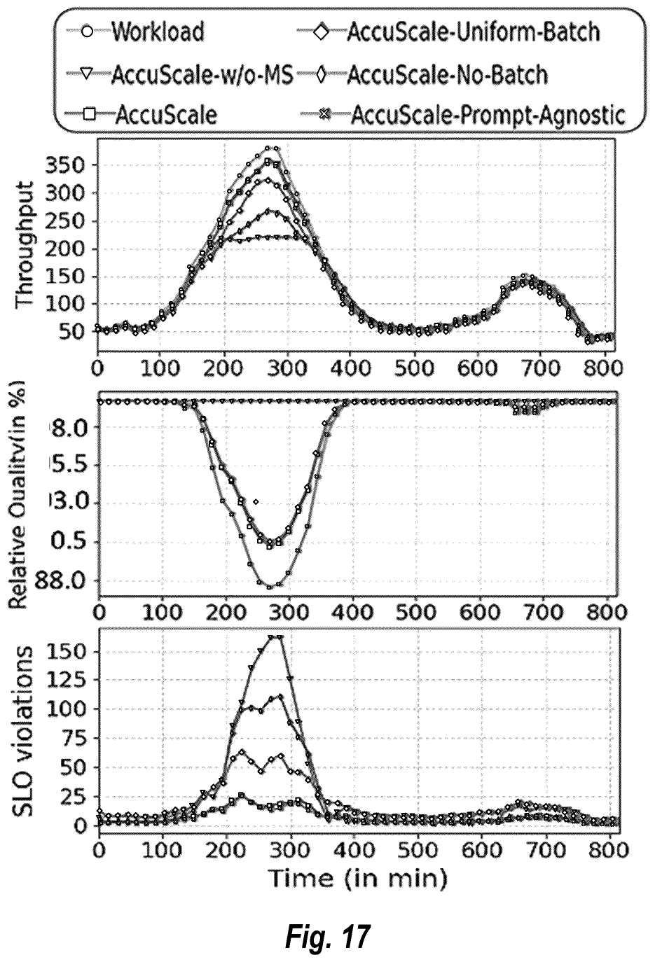

Furthermore, the Experimenters performed an ablation study to evaluate performance benefits of each component of an implementation of the prompt-aware accuracy-scaling content inference system (AccuScale) on Twitter trace. Indeed, the Experimenters used AccuScale-w/o-MS does not dynamically select models (e.g., changes in approximation level K) as an input load changes, AccuScale-Uniform-Batch (UB) represents AccuScale with only uniform routing and batching, AccuScale-No-Batch represents AccuScale without batching, AccuScale-Prompt-Agnostic represents an implementation of AccuScale that routes queries to workers based on a load distribution (without an input prompt distribution mapping). As shown in FIG. 17, AccuScale when prompt agnostic, when not using dynamic model selection, and when not using adaptive batching results in a quality (accuracy) drop and an increase in SLO violations.

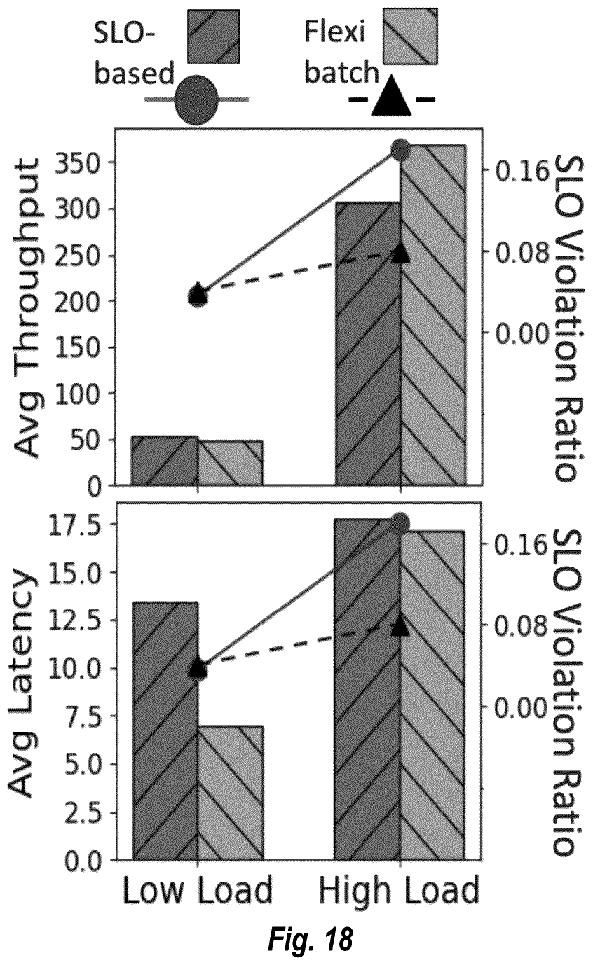

In addition, FIG. 18 illustrates the advantage of adaptive batching (“Flexi-batching”) (as described above) under low-load conditions versus high-load conditions. For instance, as shown in FIG. 18, utilizing adaptive batching to enable batching during high-load conditions results in queries running quicker compared to uniform routing (e.g., higher throughput and less SLO violations as shown on the left plot in FIG. 18). During a low-load condition, since the implementation of the prompt-aware accuracy-scaling content inference system (AccuScale) does not wait for more queries and uses uniform routing with no batching, the implementation provides lower average latency compared to SLO-based batching (as shown in FIG. 18).

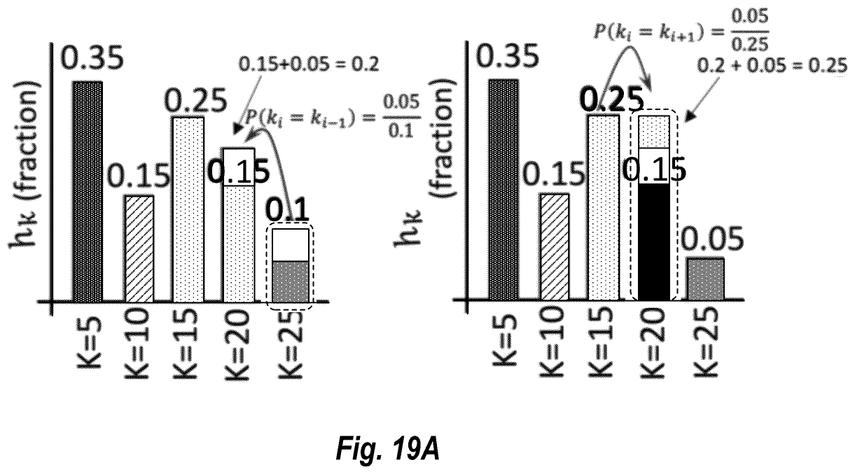

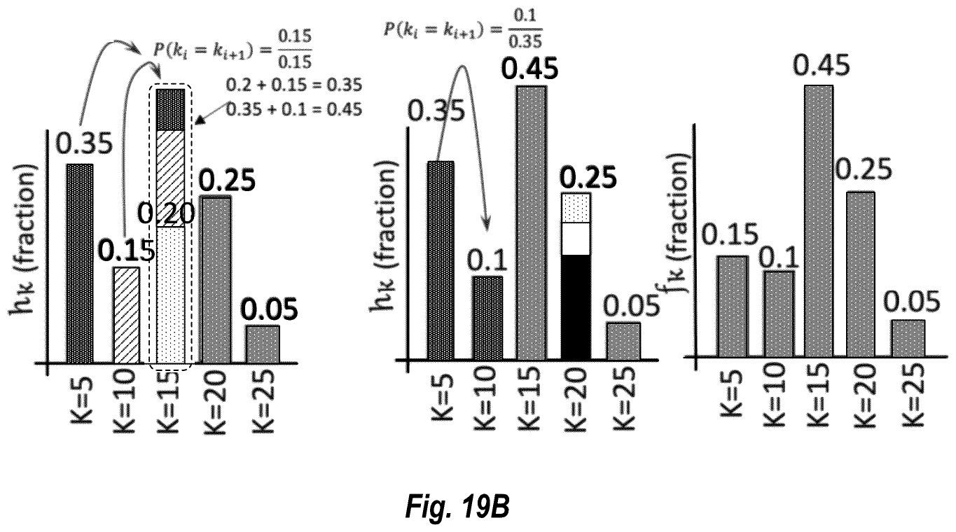

Furthermore, FIGS. 19A and 19B illustrate an example of the prompt-aware accuracy-scaling content inference system 106 generating an input prompt distribution mapping by solving historical prompt affinity mapping (H(k)) and load distribution (F(k)) shifts and probability calculations at each step. For instance, the prompt-aware accuracy-scaling content inference system 106 starts from K=25 and shifts the mass from K=25 to K=20. Moreover, as shown in FIGS. 19A-19B, at K=20, since H(k) is less than F(k), the prompt-aware accuracy-scaling content inference system 106 fills the gap by bringing prompts from K=10.

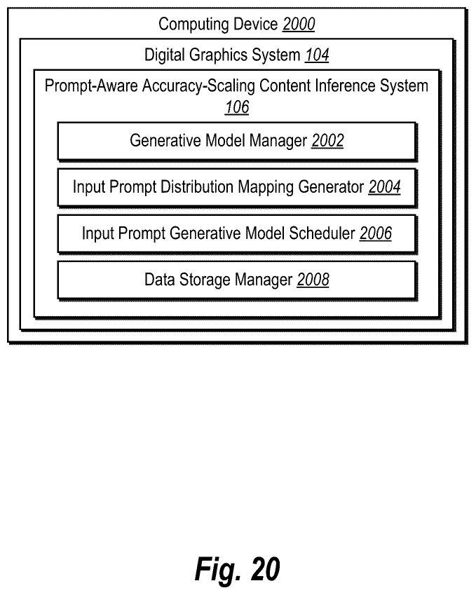

Turning now to FIG. 20, additional detail will be provided regarding components and capabilities of one or more embodiments of the prompt-aware accuracy-scaling content inference system. In particular, FIG. 20 illustrates an example prompt-aware accuracy-scaling content inference system 106 executed by a computing device 2000 (e.g., the server device(s) 102 and/or the client devices 110a-110n). As shown by the embodiment of FIG. 20, the computing device 2000 includes or hosts the digital graphics system 104 and the prompt-aware accuracy-scaling content inference system 106. Furthermore, as shown in FIG. 20, the digital graphics system 104 includes a generative model manager 2002, an input prompt distribution mapping generator 2004, an input prompt generative model scheduler 2006, and data storage manager 2008.

As just mentioned, and as illustrated in the embodiment of FIG. 20, the prompt-aware accuracy-scaling content inference system 106 includes the generative model manager 2002. For example, the generative model manager 2002 generates inference outputs for input prompts (or queries) as described above (e.g., in relation to FIGS. 2-4 and 9). Furthermore, in some instances, the generative model manager 2002 configures one or more approximation parameters for the generative models as described above (e.g., in relation to FIGS. 2-5).

Moreover, as shown in FIG. 20, the prompt-aware accuracy-scaling content inference system 106 includes the input prompt distribution mapping generator 2004. In some cases, the input prompt distribution mapping generator 2004 determines an input prompt load distribution as described above (e.g., in relation to FIGS. 2-4, and 6). Furthermore, in one or more embodiments, the input prompt distribution mapping generator 2004 also generates a historical prompt affinity mapping as described above (e.g., in relation to FIGS. 2-4 and 7). Moreover, in one or more implementations, the input prompt distribution mapping generator 2004 utilizes the input prompt load distribution and the historical prompt affinity mapping to generate an input prompt distribution mapping to enable prompt aware scheduling of one or more input prompts across generative model variants operating at varying approximation levels as described above (e.g., in relation to FIGS. 2-4 and 8-9).

Furthermore, as shown in FIG. 20, the prompt-aware accuracy-scaling content inference system 106 includes the input prompt generative model scheduler 2006. In some embodiments, the input prompt generative model scheduler 2006 selects a generative model for an input prompt utilizing an input prompt distribution mapping to generate an inference output (while maintaining throughput and output quality) as described above (e.g., in relation to FIGS. 2-2-4 and 9). In certain instances, the input prompt generative model scheduler 2006 also utilizes load aware routing and adaptive batching to schedule input prompts at generative model variants as described above (e.g., in relation to FIGS. 2-4 and 10).

As further shown in FIG. 20, the prompt-aware accuracy-scaling content inference system 106 includes the data storage manager 2008. In some embodiments, the data storage manager 2008 maintains data to perform one or more functions of the prompt-aware accuracy-scaling content inference system 106. For example, the data storage manager 2008 includes generative models (with varying approximation levels), machine learning model parameters (e.g., approximation parameters), cached input prompt data (e.g., embeddings, cached noise iterations, target approximation parameters), system data (e.g., target throughput thresholds, target output quality thresholds, threshold input prompt loads), input load data, historical prompt affinity mappings, prompt load distributions, input prompt distribution mappings, and/or cached inference outputs.

Each of the components 2002-2008 of the computing device 2000 (e.g., the computing device 2000 implementing the prompt-aware accuracy-scaling content inference system 106), as shown in FIG. 20, may be in communication with one another using any suitable technology. The components 2002-2008 of the computing device 2000 can comprise software, hardware, or both. For example, the components 2002-2008 can comprise one or more instructions stored on a computer-readable storage medium and executable by processor of one or more computing devices. When executed by the one or more processors, the computer-executable instructions of the prompt-aware accuracy-scaling content inference system 106 (e.g., via the computing device 2000) can cause a client device and/or server device to perform the methods described herein. Alternatively, the components 2002-2008 and their corresponding elements can comprise hardware, such as a special purpose processing device to perform a certain function or group of functions. Additionally, the components 2002-2008 can comprise a combination of computer-executable instructions and hardware.

Furthermore, the components 2002-2008 of the prompt-aware accuracy-scaling content inference system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 2002-2008 may be implemented as a stand-alone application, such as a desktop or mobile application. Furthermore, the components 2002-2008 may be implemented as one or more web-based applications hosted on a remote server. The components 2002-2008 may also be implemented in a suite of mobile device applications or “apps.” To illustrate, the components 2002-2008 may be implemented in an application, including but not limited to, ADOBE PHOTOSHOP, ADOBE PREMIERE, ADOBE LIGHTROOM, ADOBE ILLUSTRATOR, or ADOBE SUBSTANCE. “ADOBE,” “ADOBE PHOTOSHOP,” “ADOBE PREMIERE,” “ADOBE LIGHTROOM,” “ADOBE ILLUSTRATOR,” or “ADOBE SUBSTANCE” are either registered trademarks or trademarks of Adobe Inc. in the United States and/or other countries.

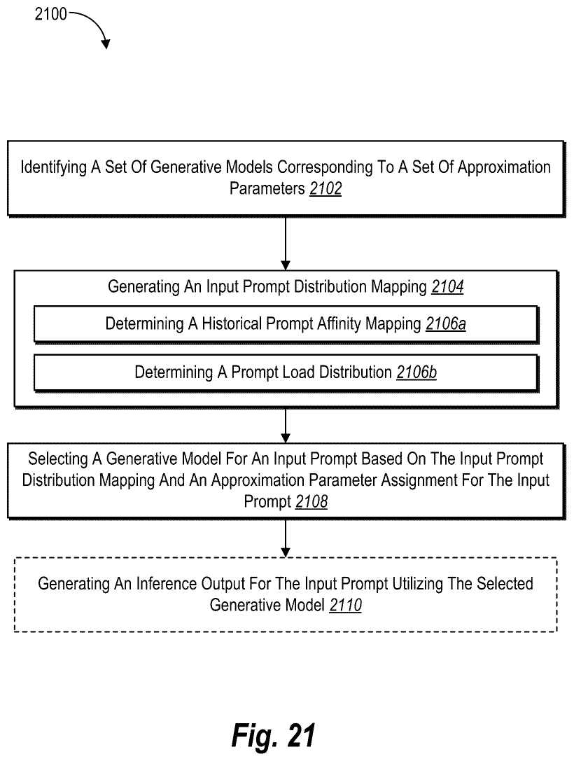

FIGS. 1-20, the corresponding text, and the examples provide a number of different methods, systems, devices, and non-transitory computer-readable media of the prompt-aware accuracy-scaling content inference system 106. In addition to the foregoing, one or more embodiments can also be described in terms of flowcharts comprising acts for accomplishing a particular result, as shown in FIG. 21. The acts shown in FIG. 21 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 21. In some embodiments, a system can be configured to perform the acts of FIG. 21. Alternatively, the acts of FIG. 21 can be performed as part of a computer implemented method.

As mentioned above, FIG. 21 illustrates a flowchart of a series of acts 2100 for utilizing prompt-aware, accuracy-scaling inference serving to serve prompts into generative models in accordance with one or more implementations. While FIG. 21 illustrates acts according to one embodiment, alternative embodiments may omit, add to, reorder, and/or modify any of the acts shown in FIG. 21.

As shown in FIG. 21, the series of acts 2100 include an act 2102 of identifying a set of generative models corresponding to a set of approximation parameters. In some cases, the act 2102 includes determining a set of approximation parameters for a set of generative models based on a predicted input prompt load. Moreover, in some instances, the act 2102 includes identifying a set of generative models corresponding to different approximation parameters.

In addition, as shown in FIG. 21, the series of acts 2100 include an act 2104 of generating an input prompt distribution mapping. For instance, the act 2104 includes generating an input prompt distribution mapping utilizing a historical prompt affinity mapping to the set of generative models and a prompt load distribution for the set of generative models. In one or more cases, the act 2104 includes generating an input prompt distribution mapping utilizing a historical prompt affinity mapping to the set of generative models and a prompt load distribution for the set of generative models. Moreover, in one or more implementations, the act 2104 includes determining a prompt shift probability utilizing the historical prompt affinity mapping and the prompt load distribution.

As further shown in FIG. 21, the act 2104 further includes an act 2106a of determining a historical prompt affinity mapping. In some cases, the act 2106a includes determining a historical prompt affinity mapping to the set of generative models utilizing affinities between historical prompts and generative models from the set of generative models. Furthermore, as shown in FIG. 21, the act 2104 also includes an act 2106b of determining a prompt load distribution. Indeed, in some instances, the act 2106b includes identifying a prompt load distribution for the set of generative models.

Furthermore, as shown in FIG. 21, the series of acts 2100 include an act 2108 of selecting a generative model for an input prompt based on the input prompt distribution mapping and an approximation parameter assignment for the input prompt. For example, the act 2108 includes selecting, for an input prompt, a generative model corresponding to a particular approximation parameter based on the input prompt distribution mapping and an approximation parameter assignment for the input prompt. In some cases, the act 2108 includes identifying an input prompt requesting content generation through generative models, wherein the input prompt corresponds to an approximation parameter assignment and selecting, from the set of generative models, a generative model for the input prompt by utilizing the input prompt distribution mapping and the approximation parameter assignment for the input prompt.

In one or more instances, the act 2108 includes utilizing an input prompt with a generative model, from the set of generative models by determining an approximation parameter assignment for the input prompt based on a similarity between the input prompt and a historical input prompt comprising a target approximation parameter and selecting the generative model corresponding to an additional target approximation parameter for the input prompt based on the input prompt distribution mapping and the target approximation parameter.

In some instances, as shown in FIG. 21, the series of acts 2100 include an act 2110 of generating an inference output for the input prompt utilizing the selected generative model. For instance, the act 2110 includes generating an inference output for the input prompt by utilizing the input prompt with the generative model.

For example, the set of generative models include a set of text-to-image diffusion models. Moreover, in some cases, the input prompt includes a text prompt requesting an image based on a description in the text prompt. Lastly, in one or more embodiments, an inference output includes an output image.

Furthermore, in some implementations, the series of acts 2100 include determining an approximation parameter for the generative model by configuring a number of skipped denoising iterations for the generative model based on the predicted input prompt load. In some cases, the series of acts 2100 include determining the different approximation parameters by modifying a set of approximation parameters corresponding to the set of generative models based on a predicted input prompt load. For example, an approximation parameter includes a number of skipped denoising iterations.

For instance, a set of generative models include a set of text-to-image diffusion models. In some implementations, the series of acts 2100 include determining the different approximation parameters by configuring a number of skipped denoising iterations for the set of text-to-image diffusion models.

In some cases, the series of acts 2100 include determining the historical prompt affinity mapping to the set of generative models by determining, for a historical prompt, a target approximation parameter based on image quality scores corresponding to output images generated by the set of generative models for the historical prompt.

Furthermore, in some instances, the series of acts 2100 include determining a load distribution for the set of generative models corresponding to the set of approximation parameters by determining a fraction of input prompts to process at each generative model from the set of generative models (to satisfy a throughput target).

Additionally, in one or more instances, the series of acts 2100 include generating the input prompt distribution mapping by determining prompt shift probabilities that represent redirection probabilities for historical prompts to particular generative models based on target approximation parameters of the historical prompts from the historical prompt affinity mapping fitting the prompt load distribution. In some implementations, the series of acts 2100 include determining the prompt shift probability by determining redirection probabilities for the historical prompts to particular generative models based on target approximation parameters of the historical prompts from the historical prompt affinity mapping fitting the prompt load distribution. In some cases, the series of acts 2100 include determining the input prompt distribution mapping by determining prompt shift probabilities that indicate redirection probabilities for historical prompts based on target approximation parameters of the historical prompts from the historical prompt affinity mapping fitting the prompt load distribution.

Furthermore, in some instances, the series of acts 2100 include determining an approximation parameter assignment for the input prompt by identifying a historical prompt for the input prompt based on a similarity score between the historical prompt and the input prompt and/or mapping a target approximation parameter corresponding to the historical prompt to the input prompt. In some implementations, the series of acts 2100 include determining the additional target approximation parameter for the input prompt based on an availability of the target approximation parameter in the input prompt distribution mapping. Moreover, in some implementations, the series of acts 2100 include generating an inference output for the input prompt by utilizing the input prompt with the generative model at an approximation level corresponding to the additional target approximation parameter.

In some cases, the series of acts 2100 include selecting the generative model for the input prompt by determining a redirected approximation parameter for the input prompt based on an availability of the approximation parameter assignment in the input prompt distribution mapping and/or selecting the generative model, from the set of generative models, corresponding to the redirected approximation parameter.

Additionally, in one or more instances, the series of acts 2100 include selecting, for an additional input prompt, the generative model corresponding to the particular approximation parameter based on the input prompt distribution mapping and an additional approximation parameter assignment for the additional input prompt. Furthermore, in one or more cases, the series of acts 2100 include, upon determining that the input prompt and the additional input prompt satisfies an input prompt load threshold, generating a batch inference output by utilizing the input prompt and the additional input prompt as a batch of input prompts with the generative model.

In some instances, the series of acts 2100 include identifying an updated predicted input prompt load. Moreover, in some cases, the series of acts 2100 include determining an updated set of approximation parameters for the set of generative models. Additionally, in one or more embodiments, the series of acts 2100 include generating an updated input prompt distribution mapping based on the updated predicted input prompt load. Moreover, in one or more cases, the series of acts 2100 include selecting, for an additional input prompt, an additional generative model corresponding to an additional particular approximation parameter based on the updated input prompt distribution mapping.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 22 illustrates a block diagram of an example computing device 2200 that may be configured to perform one or more of the processes described above. One will appreciate that one or more computing devices, such as the computing device 2200 may represent the computing devices described above (e.g., the server device(s) 102 and/or the client devices 110a-110n). In one or more implementations, the computing device 2200 may be a mobile device (e.g., a mobile telephone, a smartphone, a PDA, a tablet, a laptop, a camera, a tracker, a watch, a wearable device, etc.). In some implementations, the computing device 2200 may be a non-mobile device (e.g., a desktop computer or another type of client device). Further, the computing device 2200 may be a server device that includes cloud-based processing and storage capabilities.

As shown in FIG. 22, the computing device 2200 can include one or more processor(s) 2202, memory 2204, a storage device 2206, input/output interfaces 2208 (or “I/O interfaces 2208”), and a communication interface 2210, which may be communicatively coupled by way of a communication infrastructure (e.g., bus 2212). While the computing device 2200 is shown in FIG. 22, the components illustrated in FIG. 22 are not intended to be limiting. Additional or alternative components may be used in other implementations. Furthermore, in certain implementations, the computing device 2200 includes fewer components than those shown in FIG. 22. Components of the computing device 2200 shown in FIG. 22 will now be described in additional detail.

In particular implementations, the processor(s) 2202 includes hardware for executing instructions, such as those making up a computer program. As an example, and not by way of limitation, to execute instructions, the processor(s) 2202 may retrieve (or fetch) the instructions from an internal register, an internal cache, memory 2204, or a storage device 2206 and decode and execute them.

The computing device 2200 includes memory 2204, which is coupled to the processor(s) 2202. The memory 2204 may be used for storing data, metadata, and programs for execution by the processor(s). The memory 2204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 2204 may be internal or distributed memory.

The computing device 2200 includes a storage device 2206 includes storage for storing data or instructions. As an example, and not by way of limitation, the storage device 2206 can include a non-transitory storage medium described above. The storage device 2206 may include a hard disk drive (“HDD”), flash memory, a Universal Serial Bus (“USB”) drive or a combination these or other storage devices.

As shown, the computing device 2200 includes one or more I/O interfaces 2208, which are provided to allow a user to provide input to (such as user strokes), receive output from, and otherwise transfer data to and from the computing device 2200. These I/O interfaces 2208 may include a mouse, keypad or a keyboard, a touch screen, camera, optical scanner, network interface, modem, other known I/O devices or a combination of such I/O interfaces 2208. The touch screen may be activated with a stylus or a finger.

The I/O interfaces 2208 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interfaces 2208 are configured to provide graphical data to a display for presentation to a user. The graphical data may be representative of one or more graphical user interfaces and/or any other graphical content as may serve a particular implementation.

The computing device 2200 can further include a communication interface 2210. The communication interface 2210 can include hardware, software, or both. The communication interface 2210 provides one or more interfaces for communication (such as, for example, packet-based communication) between the computing device and one or more other computing devices or one or more networks. As an example, and not by way of limitation, communication interface 2210 may include a network interface controller (“NIC”) or network adapter for communicating with an Ethernet or other wire-based network or a wireless NIC (“WNIC”) or wireless adapter for communicating with a wireless network, such as a WI-FI. The computing device 2200 can further include a bus 2212. The bus 2212 can include hardware, software, or both that connects components of the computing device 2200 to each other.

In the foregoing specification, the invention has been described with reference to specific example implementations thereof. Various implementations and aspects of the invention(s) are described with reference to details discussed herein, and the accompanying drawings illustrate the various implementations. The description above and drawings are illustrative of the invention and are not to be construed as limiting the invention. Numerous specific details are described to provide a thorough understanding of various implementations of the present invention.

The present invention may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining a set of approximation parameters for a set of generative models based on a predicted input prompt load;
generating an input prompt distribution mapping utilizing a historical prompt affinity mapping to the set of generative models and a prompt load distribution for the set of generative models;
selecting, for an input prompt, a generative model corresponding to a particular approximation parameter based on the input prompt distribution mapping and an approximation parameter assignment for the input prompt; and
generating an inference output for the input prompt by utilizing the input prompt with the generative model.

2. The computer-implemented method of claim 1, further comprising determining an approximation parameter for the generative model by configuring a number of skipped denoising iterations for the generative model based on the predicted input prompt load.

3. The computer-implemented method of claim 1, further comprising determining the historical prompt affinity mapping to the set of generative models by determining, for a historical prompt, a target approximation parameter based on image quality scores corresponding to output images generated by the set of generative models for the historical prompt.

4. The computer-implemented method of claim 1, further comprising determining a load distribution for the set of generative models corresponding to the set of approximation parameters by determining a fraction of input prompts to process at each generative model from the set of generative models to satisfy a throughput target.

5. The computer-implemented method of claim 1, further comprising generating the input prompt distribution mapping by determining prompt shift probabilities that represent redirection probabilities for historical prompts to particular generative models based on target approximation parameters of the historical prompts from the historical prompt affinity mapping fitting the prompt load distribution.

6. The computer-implemented method of claim 1, further comprising determining an approximation parameter assignment for the input prompt by:
identifying a historical prompt for the input prompt based on a similarity score between the historical prompt and the input prompt; and
mapping a target approximation parameter corresponding to the historical prompt to the input prompt.

7. The computer-implemented method of claim 1, further comprising:
selecting, for an additional input prompt, the generative model corresponding to the particular approximation parameter based on the input prompt distribution mapping and an additional approximation parameter assignment for the additional input prompt; and
upon determining that the input prompt and the additional input prompt satisfies an input prompt load threshold, generating a batch inference output by utilizing the input prompt and the additional input prompt as a batch of input prompts with the generative model.

8. The computer-implemented method of claim 1, wherein:
the set of generative models comprise a set of text-to-image diffusion models;
the input prompt comprises a text prompt requesting an image based on a description in the text prompt; and
the inference output comprises an output image.

9. The computer-implemented method of claim 8, further comprising:
identifying an updated predicted input prompt load;
determining an updated set of approximation parameters for the set of generative models;
generating an updated input prompt distribution mapping based on the updated predicted input prompt load; and
selecting, for an additional input prompt, an additional generative model corresponding to an additional particular approximation parameter based on the updated input prompt distribution mapping.

10. A non-transitory computer-readable medium storing instructions that, when executed by at least one processor, cause the at least one processor to perform operations comprising:
identifying a set of generative models corresponding to different approximation parameters;
generating an input prompt distribution mapping by:
identifying a prompt load distribution for the set of generative models;
determining a historical prompt affinity mapping to the set of generative models utilizing affinities between historical prompts and generative models from the set of generative models; and
determining a prompt shift probability utilizing the historical prompt affinity mapping and the prompt load distribution;
identifying an input prompt requesting content generation through generative models, wherein the input prompt corresponds to an approximation parameter assignment; and
selecting, from the set of generative models, a generative model for the input prompt by utilizing the input prompt distribution mapping and the approximation parameter assignment for the input prompt.

11. The non-transitory computer-readable medium of claim 10, wherein the operations further comprise determining the different approximation parameters by modifying a set of approximation parameters corresponding to the set of generative models based on a predicted input prompt load, wherein an approximation parameter comprises a number of skipped denoising iterations.

12. The non-transitory computer-readable medium of claim 10, wherein the operations further comprise identifying the prompt load distribution by determining a fraction of input prompts to process at each generative model from the set of generative models.

13. The non-transitory computer-readable medium of claim 10, wherein the operations further comprise determining the approximation parameter assignment for the input prompt by:
identifying a historical prompt for the input prompt based on a similarity score between the historical prompt and the input prompt; and
mapping a target approximation parameter corresponding to the historical prompt to the input prompt.

14. The non-transitory computer-readable medium of claim 13, wherein the operations further comprise selecting the generative model for the input prompt by:
determining a redirected approximation parameter for the input prompt based on an availability of the approximation parameter assignment in the input prompt distribution mapping; and
selecting the generative model, from the set of generative models, corresponding to the redirected approximation parameter.

15. The non-transitory computer-readable medium of claim 10, wherein the operations further comprise determining the prompt shift probability by determining redirection probabilities for the historical prompts to particular generative models based on target approximation parameters of the historical prompts from the historical prompt affinity mapping fitting the prompt load distribution.

16. A system comprising:
a memory component comprising a set of generative models corresponding to different approximation parameters; and
a processing device coupled to the memory component, the processing device to perform operations comprising:
generating an input prompt distribution mapping utilizing a historical prompt affinity mapping to the set of generative models and a prompt load distribution for the set of generative models; and
utilizing an input prompt with a generative model, from the set of generative models, by:
determining an approximation parameter assignment for the input prompt based on a similarity between the input prompt and a historical input prompt comprising a target approximation parameter; and
selecting the generative model corresponding to an additional target approximation parameter for the input prompt based on the input prompt distribution mapping and the target approximation parameter.

17. The system of claim 16, wherein the set of generative models comprise a set of text-to-image diffusion models and wherein the operations further comprise determining the different approximation parameters by configuring a number of skipped denoising iterations for the set of text-to-image diffusion models.

18. The system of claim 16, wherein the operations further comprise determining the input prompt distribution mapping by determining prompt shift probabilities that indicate redirection probabilities for historical prompts based on target approximation parameters of the historical prompts from the historical prompt affinity mapping fitting the prompt load distribution.

19. The system of claim 18, wherein the operations further comprise determining the additional target approximation parameter for the input prompt based on an availability of the target approximation parameter in the input prompt distribution mapping.

20. The system of claim 19, wherein the operations further comprise generating an inference output for the input prompt by utilizing the input prompt with the generative model at an approximation level corresponding to the additional target approximation parameter.
